(19) United States
(12) Patent Application Publication
(10) Pub. No.: US 2015/0302442 A1
(43) Pub. Date: Oct. 22, 2015

(54) SYSTEM AND METHOD FOR VISUALLY BUILDING A MARKET SIMULATION

(71) Applicant: Edwin Geoffrey Hartnell, Malpitas, CA (US)

(72) Inventor: Edwin Geoffrey Hartnell, Malpitas, CA (US)

(21) Appl. No.: 14/752,921

(22) Filed: Jun. 27, 2015

Related U.S. Application Data
(63) Continuation of application No. 12/391,408, filed on Feb. 24, 2009.

(51) Int. Cl. G06Q 30/02

(52) U.S. Cl. CPC G06Q 30/0206

(57) ABSTRACT

The market simulator/optimizer of the present invention combines partworth valuation techniques of Conjoint analysis with Nash equilibrium profit-maximization methodologies for sophisticated statistical treatment of a virtual available market comprising a multiplicity of virtual customers. An easy-to-use graphical user interface allows a user to arrange various market component icons to model various market characteristics. Associated with the market component icons are various distributions, including a benefit distribution containing values indicative of respective benefits to the multiplicity of virtual customer, and a cost distribution containing values indicative of respective costs associated with providing the respective benefits to the multiplicity of virtual customers.

### RELATED APPLICATIONS

This application is a continuation of and claims priority to U.S. patent application Ser. No. 12/391,408, entitled “SYSTEM AND METHOD FOR PROVIDING MARKET SIMULATION/OPTIMIZATION” filed Feb. 24, 2009, which is currently pending, the contents of which is herein incorporated by reference in its entirety.

### FIELD OF THE INVENTION

The present invention is generally related to a market simulator or optimizer, and more particularly is related to a system and method for market simulation or optimization in which generation of virtual partworth data in combination with a simple yet sophisticated graphical user interface permits increased versatility and flexibility in modeling market behavior.

### BACKGROUND OF THE INVENTION

Information available to marketing decision makers to assist them in making marketing decisions can, for example, come in the form of market reports, consumer surveys, and institutional knowledge. Market reports are generally available for purchase from vendors specializing in the collection and dissemination of data about a market. The information within such reports comprises competitor overviews, product reviews, pricing comparisons, and market share data. Consumer surveys can reveal more information about the likes and dislikes of individual consumers (this information typically being lost in market reports, which tend to aggregate those results). Tools, such as Conjoint analysis, can be applied to consumer surveys to allow business managers to break products down by feature so as to quantify the value each feature provides within a partworth customer distribution.

A Conjoint analysis would typically investigate relative value of some discrete number of “levels” of a given “attribute.” For example, a Conjoint analysis for automobiles may derive partworth values for a “4-cylinder” level, a “6-cylinder” level, and an “8-cylinder” level of the “engine” attribute. Conjoint analysis researchers might then run a simulation that would find the optimal collection of levels for each attribute. Such tools provide business managers with the means to simulate future market conditions, thereby leading to better decision making.

Traditional Conjoint analysis generally requires that a consumer survey be conducted to determine partworth values for a representative sample of customers in a given market. Such consumer surveys are typically conducted by professional market researchers and are often expensive and time-consuming. Furthermore, as such studies can generate an enormous amount of data, entry and manipulation of such data can be cumbersome. There is therefore a need for a market simulator/optimizer that would permit inexpensive and rapid generation of its own internal partworth data and/or would permit easy entry of partworth data coming from one or more external sources.

In addition, where multiple surveys are performed, it is not generally possible to aggregate multiple survey results together. This has been a source of frustration for business managers, because survey results often fail to progress beyond elemental market insights. Any change in the market under study can therefore require that research be conducted anew, as techniques are not generally available that would make it possible to leverage off of existing partworth data, such as might be desired to reflect changing demographics or entry of new products on the marketplace, for example. Moreover, even where additional Conjoint studies are conducted to address new features or products, for example, there is generally no provision for combining such disparate data into a single market model, since the data from separately conducted studies is generally mutually incompatible using conventional methods, and it is thus not clear how such disparate data might be seamlessly combined into a single synthetic model of the market. Likewise, institutional knowledge, which encompasses the personal experiences of all employees within an organization, is often rich and diverse, sometimes comprising centuries of accumulated exposure to a market. However, very few tools exist that are capable of satisfactorily aggregating an organization's institutional knowledge. Hence, such institutional knowledge is rarely taken full advantage of when making business decisions. There is likewise generally no ability in the conventional art that would allow the knowledge and intuition of experienced marketing professionals to be reflected in or conveniently combined with such research data. There is therefore a need for a market simulator/optimizer that would permit mixing and matching of partworth data from a variety of sources, including an institution's own intuition about the marketplace.

As mentioned above, traditional Conjoint analysis investigates relative preference of customers for discrete levels of discontinuous product attributes. Furthermore, traditional Conjoint tools generally assume that the benefit offered by a feature contributes equally to all products in the market that offer that feature. Such tools moreover generally give no consideration to the continuous steady improvement of the existing set of features within a product. Such tools likewise generally give no consideration to modeling continuous market trends impacting some or all of the products in the market at a more macroeconomic level. Such conventional tools offer no mechanism to combine the simulation of these continuous trends with the optimal selection of discrete feature into products. In addition, traditional Conjoint analysis tools offer no mechanism to consider geographic store location. There is therefore a need for a market simulator/optimizer that would overcome such drawbacks of conventional Conjoint analysis and conventional Conjoint-based tools.

Furthermore, traditional Conjoint studies typically treat price as an independent variable, with survey participants being asked such questions as “Would you purchase Product A if it were priced at $10.00?”, when it would be more natural and useful from a marketing standpoint to treat price as a dependent variable, the value of which would be better understood to flow as a natural consequence of the consumer surplus accruing to a purchaser after subtracting price from the perceived benefit of the product to the purchaser. For example, a traditional customer survey might reveal that “pricing at $10 is more profitable than pricing at $20” but be unable to determine that “pricing at $15 is optimal”. Such conventional simulations therefore fail to find a profit-maximizing point at a price other than that specifically surveyed. Conventional simulations generally fail to make the connection between the partworth value (often as measured in the fictitious “utils” unit) and the equivalent dollar values that such partworth values represent. There is therefore a need for a better way to model price in the context of partworth simulations.

Moreover, conventionally, heterogeneity in the marketplace is often modeled in an ad hoc manner. For example, some conventional techniques introduce a random component in combination with partworth data in an attempt to simulate observed real-world purchasing decisions of consumers. However, such conventional techniques have the disadvantage that they merely introduce various “fudge factors” to achieve observed market behavior. It is therefore desired to model market heterogeneity in a more natural way that reflects the observed or expected heterogeneity of the marketplace.

Moreover, currently available Conjoint- and Nash-based software is generally difficult to use, and being less than intuitive with respect to data entry and presentation of results, does not have the transparency and convenience requisite for credible communication among corporate decision makers.

Thus, a heretofore unaddressed need exists in the industry to address the aforementioned deficiencies and inadequacies.

### SUMMARY OF THE INVENTION

The market simulator/optimizer of the present invention combines partworth valuation techniques of Conjoint analysis with Nash equilibrium profit-maximization methodologies for sophisticated statistical treatment of a virtual available market comprising a multiplicity of virtual customers. An easy-to-use graphical user interface allows a user to arrange various market component icons to model various market characteristics. Associated with the market component icons are various distributions, including benefit distributions containing values indicative of respective benefits to the multiplicity of virtual customers, and cost distributions containing values indicative of respective costs associated with providing the respective benefits to the multiplicity of virtual customers.

A market simulator/optimizer in accordance with one aspect of the present invention comprises a graphical user interface accepting alphanumeric input and permitting arrangement of icons on a display by a user; an output device capable of outputting results of processing; a memory; and a processor configured by the memory to perform the steps of allowing a user to use the graphical user interface to arrange one or more icons and enter one or more parameters representing one or more products in a market; generating at least one data structure associated with at least one feature of at least one of the product or products, the data structure comprising a benefit distribution containing values indicative of respective benefits of that feature to each of a multiplicity of virtual customers; implementing a profit maximization engine that finds a profit maximizing equilibrium point based at least partially on the data structure; and outputting to the output device at least one market metric determined to apply to the profit-maximizing equilibrium point.

A system for simulating a market in accordance with another aspect of the present invention comprises a memory and comprises a processor configured by the memory to perform the steps of providing a graphical user interface that allows a user to arrange one or more icons and enter one or more parameters representing one or more products in a market; generating at least one data structure associated with at least one feature of at least one of the product or products, the data structure comprising a benefit distribution containing values indicative of respective benefits of that feature to each of a multiplicity of virtual customers; implementing a profit maximization engine that finds a profit-maximizing equilibrium point based at least partially on the data structure; and outputting at least one market metric determined to apply to the profit-maximizing equilibrium point.

Here, the data structure may further comprise a cost distribution containing values indicative of respective costs associated with providing the respective benefits to each of the virtual customers.

Furthermore, at least one of the icon or icons may be an icon indicative of a price competitive or non-competitive group, and the profit maximization engine may employ a pricing funnel to find the profit-maximizing equilibrium point.

Moreover, the benefit distribution may be statistically generated such that the respective benefits of the respective virtual customers conform to a substantially random distribution admitting of characterization in terms of mean and correlation values relative to a second benefit distribution.

The profit maximization engine may be used in iterative fashion to generate a results matrix relating a market metric to a series of benefit distributions having varying mean and correlation values relative to a baseline benefit distribution.

There may be a plurality of the icons, and at least two of the icons may be selected from among the group consisting of an icon representing demographic information, an icon representing geographic distribution channel information, an icon representing external partworth data, an icon representing internally generated partworth data, an icon representing one or more filtering operations to be performed on partworth data, an icon representing generation of partworth data that is scaled by a first factor relative to other partworth data, an icon representing generation of partworth data that has a first degree of correlation relative to other partworth data, an icon representing aggregation of connected components into a cumulative benefit, an icon indicative of a price-competitive or non-competitive group, an icon representing handoff to a profit maximization engine, an icon representing switching among discrete levels of an attribute, and an icon representing tweening of a parameter.

The benefit distribution may have a shape that is selected from among the group consisting of Gaussian distribution shape, Bernoulli distribution shape, binomial distribution shape, Poisson distribution shape, sinusoidal distribution shape, uniform distribution shape, and patterned distribution shape.

The market metric may be one or more items selected from among the group consisting of product price, market share by quantity of product sold, market share by revenue from sale of product, market share by product profitability, marginal cost of product sold, implicit customer rating of respective product features, and implicit product similarity.

Another aspect of the present invention is a networked market simulator system in which one or more market simulators/optimizers as described above are arranged in distributed fashion such that a server machine is connected by way of a network to a plurality of client machines, each of the client machines respectively providing the graphical user interface, and the server machine implementing the profit maximization engine.

Yet another aspect of the present invention is a computer-readable medium having stored thereon computer-executable instructions for configuring a processor to perform the steps of providing a graphical user interface that allows a user to arrange one or more icons and enter one or more parameters representing one or more products in a market; generating at least one data structure associated with at least one feature of at least one of the product or products, the data structure comprising a benefit distribution containing values indicative of respective benefits of that feature to each of a multiplicity of virtual customers; implementing a profit maximization engine that finds a profit-maximizing equilibrium point based at least partially on the data structure; and outputting at least one market metric determined to apply to the profit-maximizing equilibrium point.

Still another aspect of the present invention is a computer-readable medium embodying a market model data structure produced by a market simulation system as described above.

A market simulator/optimizer in accordance with one embodiment of the present invention comprises a profit maximization engine capable of determining profit-maximizing prices for simulated products based on benefit distribution and cost distributions. Such benefit distributions may contain values indicative of respective benefits to a multiplicity of virtual customers. Such cost distributions may contain values indicative of respective costs associated with providing the respective benefits to the multiplicity of virtual customers.

In accordance with yet another embodiment of the present invention, a market simulator is capable of generating a partworth distribution containing partworth values for a multiplicity of virtual customers. Such a simulator preferably allows a user to give the partworth distribution a desired distribution shape, mean, and standard deviation. Furthermore, such a simulator preferably allows a user to tune the partworth distribution to reflect vertical and horizontal differentiation in the market under study. Such tuning to reflect vertical and horizontal differentiation may be carried out by trial-and-error through use of a profit maximization engine. Alternatively or in addition thereto, such tuning to reflect vertical and horizontal differentiation may be carried out through use of isocontour curves relating vertical and horizontal differentiation to one or more market metrics.

In accordance with another embodiment of the present invention, a market simulator is capable of solving for an optimal price at which a product should be sold. In such a market simulator, competitive interactions among market participants may be iteratively modeled by a profit maximization engine. Furthermore, a first partworth distribution having a normal distribution may be obtained. Moreover, a degree of correlation between product features may be used to generate a second partworth distribution from the first partworth distribution.

Another aspect of the present invention is a graphical user interface for a market simulator. Such a graphical user interface preferably permits a user to construct an iconic map symbolically representing a market by manipulating at least two icons symbolically representing market characteristics selected from among the group consisting of an icon representing demographic information, an icon representing geographic distribution channel information, an icon representing external partworth data, an icon representing internally generated partworth data, an icon representing one or more filtering operations to be performed on partworth data, an icon representing generation of partworth data that is scaled (adjusted) in magnitude and/or degree of correlation with respect to other partworth data, an icon representing generation of partworth data that has a first degree of correlation relative to other partworth data, an icon representing aggregation of connected components into a cumulative benefit, an icon indicative of a price-competitive or non-competitive group, an icon representing handoff to a profit maximization engine, an icon representing switching among discrete levels of an attribute, and an icon representing tweening of a parameter.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an example of a general purpose computer and associated software for implementing the market simulation/optimization system of the present invention.

FIG. 2 is a schematic diagram illustrating functional blocks representing functionality defined by the software at FIG. 1, in accordance with a first exemplary embodiment of the invention.

FIG. 3 shows an example of a sector diagram, this being one of the functionalities shown in the software functional block diagram of FIG. 2.

FIG. 4 shows an exemplary set of market component icons that may be made available to a user for creation of a sector diagram such as that shown in FIG. 3.

FIG. 5 shows a schematic diagram of an example of a market model data structure, this being one of the functionalities shown in the software functional block diagram of FIG. 2.

FIG. 6 is a diagram showing relationship between cost, price, benefit, and consumer surplus, these being used by the profit maximization engine in one embodiment of the present invention.

FIG. 7 shows an example of a profit maximization engine and functional blocks associated therewith, the profit maximization engine being one of the functionalities shown in the software functional block diagram of FIG. 2.

FIG. 8 shows arrangement of icons in a sector diagram at a working example for illustrating how a market simulator/optimizer in accordance with one embodiment of the present invention is able to model vertical and horizontal differentiation.

FIG. 9 is a flowchart to assist in describing a method for using a profit maximization engine such as that shown in FIG. 7 to tune a market model such as that indicated by the sector diagram of FIG. 8.

FIG. 10 is a flowchart to assist in describing a method for using market share split isocontour curves to tune a market model such as that indicated by the sector diagram of FIG. 8 to reflect vertical and horizontal differentiation observed in a market.

FIG. 11 is a chart showing a first market share split isocontour curve plotted on a chart to show the relationship between vertical and horizontal differentiation in accordance with the procedure of the flowchart of FIG. 10.

FIG. 12 is a chart showing a second market share split isocontour curve that has been added to the chart of FIG. 11.

### DETAILED DESCRIPTION

The market simulator/optimizer of the present invention combines partworth valuation techniques of Conjoint analysis with Nash equilibrium profit-maximization methodologies for sophisticated statistical treatment of a virtual available market comprising a multiplicity of virtual customers. An easy-to-use graphical user interface allows a user to arrange icons to model various market components.

The present system and method is a graphical tool used to create and run market model simulations. The present system and method may be provided by a Web-based application. The following description assumes that the present system and method is provided by a Web-based application. It should be noted that the system and method may also be provided in an environment that is not Web-based.

The market simulation/optimization system of the invention can be implemented in software (e.g., firmware), hardware, or a combination thereof. In the currently contemplated best mode, the market simulation/optimization system is implemented in software, as an executable program, and is executed by a special or general purpose digital computer, such as a personal computer (PC; IBM-compatible, Apple-compatible, or otherwise), workstation, minicomputer, or mainframe computer. Specifically, the market simulation/optimization system, as provided by the computer, may be accessible via a Web site, through which parties using the market simulation/optimization system may interact. Further description of the market simulation/optimization system, and interaction therewith is provided below.

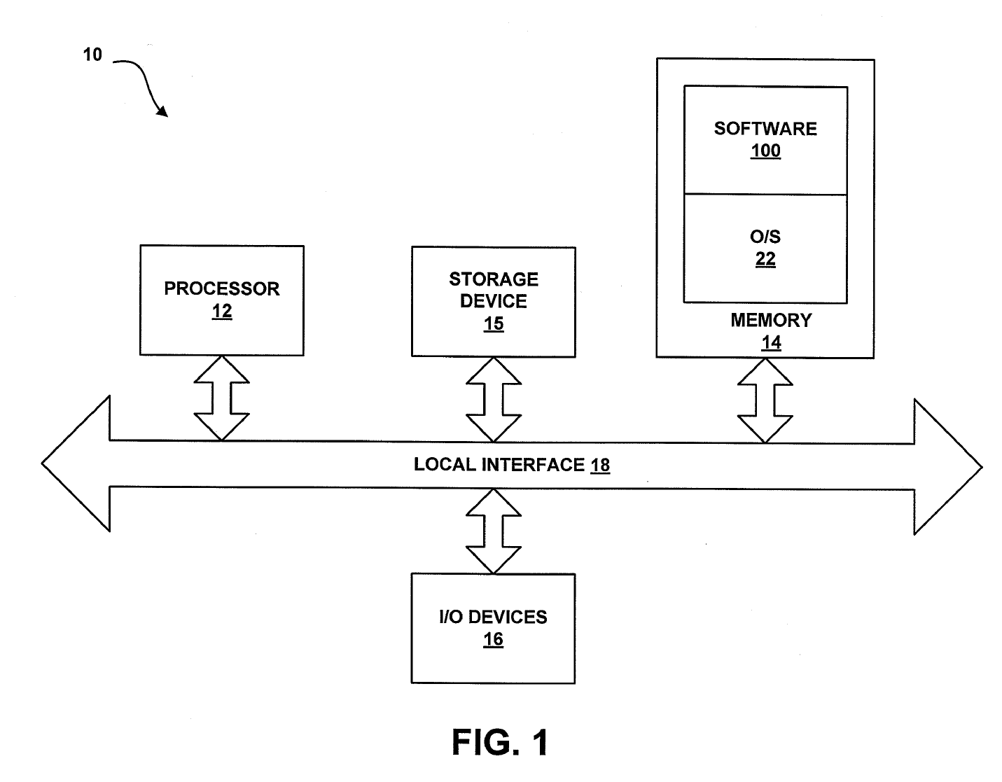

An example of a general purpose computer that can implement the market simulation/optimization system of the present invention is shown in FIG. 1. In FIG. 1, the market simulation/optimization system is denoted by reference numeral 10. It should be noted that communication with the market simulation/optimization system may be provided by multiple means such as, but not limited to, the Internet. Further description with regard to use of the market simulation/optimization system via use of the Internet is provided below.

Generally, in terms of hardware architecture, as shown in FIG. 1, the computer 10 includes a processor 12, memory 14, storage device 15, and one or more input and/or output (I/0) devices 16 (or peripherals) that are communicatively coupled via a local interface 18. The local interface 18 can be, for example but not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 12 is a hardware device for executing software, particularly that stored in the memory 14. The processor 12 can be any custom made or commercially available processor, a central processing unit (CPU), an auxiliary processor among several processors associated with the computer 10, a semiconductor based microprocessor (in the form of a microchip or chip set), a microprocessor, or generally any device for executing software instructions.

The memory 14 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 14 may incorporate electronic, magnetic, optical, and/or other types of storage media. Note that the memory 14 can have a distributed architecture, where various components are situated remote from one another, but can be accessed by the processor 12.

The software 100 in memory 14 may include one or more separate programs, each of which comprises an ordered listing of executable instructions for implementing logical functions of the market simulation/optimization system, as described below. In the example of FIG. 1, the software 100 in the memory 14 defines the market simulation/optimization system functionality in accordance with the present invention. In addition, the memory 14 may contain an operating system (0/S) 22. The operating system 22 essentially controls the execution of computer programs and provides scheduling, input-output control, file and data management, memory management, and communication control and related services.

Instructions for implementing the market simulation/optimization system 10 may be provided by a source program, executable program (object code), script, or any other entity comprising a set of instructions to be performed. When a source program, then the program needs to be translated via a compiler, assembler, interpreter, or the like, which may or may not be included within the memory 14, so as to operate properly in connection with the 0/S 22. Furthermore, instructions for implementing the market simulation/optimization system 10 can be written as (a) an object oriented programming language, which has classes of data and methods, or (b) a procedure programming language, which has routines, subroutines, and/or functions. The I/0 devices 16 may include input devices, for example but not limited to, a keyboard, mouse, scanner, microphone, etc. Furthermore, the I/0 devices 16 may also include output devices, for example but not limited to, a printer, display, etc. Finally, the I/0 devices 16 may further include devices that communicate via both inputs and outputs, for instance but not limited to, a modulator/demodulator (modem; for accessing another device, system, or network), a radio frequency (RF) or other transceiver, a telephonic interface, a bridge, a router, etc.

When the market simulation/optimization system 10 is in operation, the processor 12 is configured to execute the software 100 stored within the memory 14, to communicate data to and from the memory 14, and to generally control operations of the computer 10 pursuant to the software 100. The market simulation/optimization system 10 and the 0/S 22, in whole or in part, but typically the latter, are read by the processor 12, perhaps buffered within the processor 12, and then executed.

When the market simulation/optimization system 10 is implemented in software, as is shown in FIG. 1, it should be noted that instructions for implementing the market simulation/optimization system 10 can be stored on any computer-readable medium for use by or in connection with any computer-related system or method. Such a computer-readable medium may, in some embodiments, correspond to either or both the memory 14 or the storage device 15 shown in FIG. 1. In the context of this document, a computer-readable medium is an electronic, magnetic, optical, or other physical device or means that can contain or store a computer program for use by or in connection with a computer-related system or method. Instructions for implementing the market simulation/optimization system 10 can be embodied in any computer readable medium for use by or in connection with the processor 12 or other such instruction execution system, apparatus, or device. Although the processor 12 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means 15 Attorney Docket No 19095-6100 that can store, communicate, propagate, or transport the program for use by or in connection with the processor 12 or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the market simulation/optimization system 10 is implemented in hardware, the market simulation/optimization system 10 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

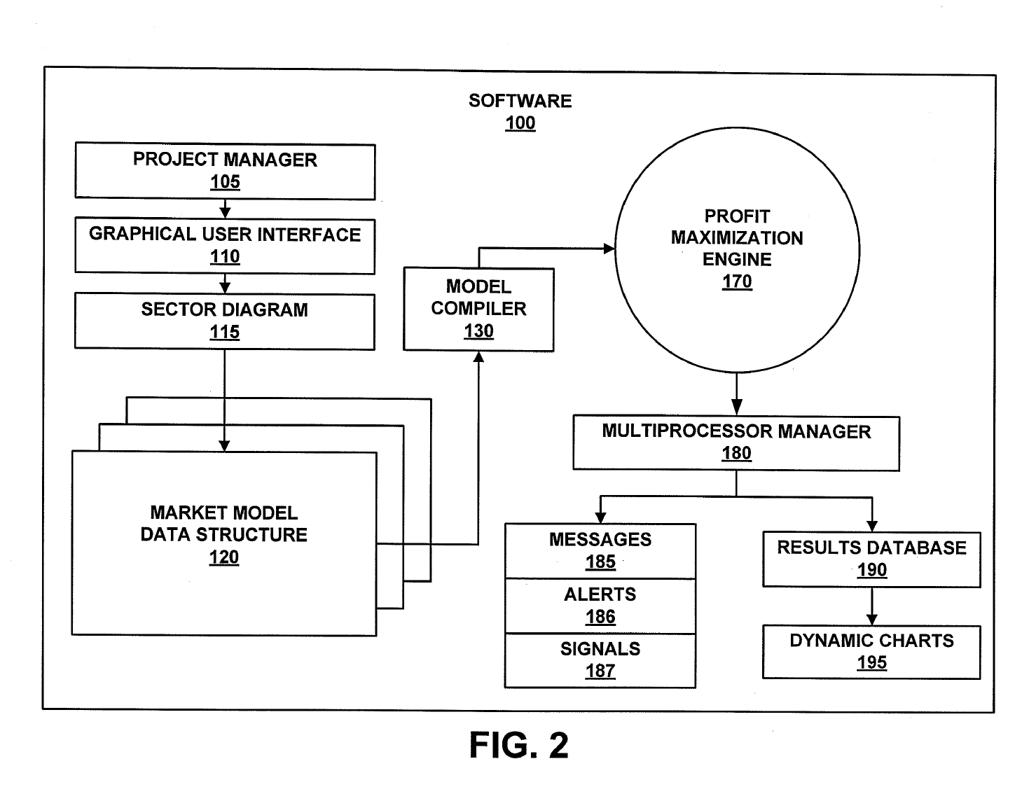

FIG. 2 is a schematic diagram further illustrating functional blocks representing functionality defined by the software 100 of FIG. 1, in accordance with a first exemplary embodiment of the invention. In accordance with the present embodiment, the software 100 includes a graphical user interface 110, a market model data structure 120, and a Nash equilibrium profit maximization engine (hereinafter “profit maximization engine”) 170. The graphical user interface 110 is located at the front end (figuratively speaking) of the software 100. The graphical user interface 110 may, for example, comprise canvases, windows, panels, toolbox, and dialog boxes. In one embodiment, canvases provide the user with a central area to create and analyze market models. The graphical user interface 110 is used to collect data input from the user in the context of a sector diagram 115 that is loaded into a drawing-canvas-like window. The graphical user interface 110 is also used to output results of simulation to the user. From the sector diagram 115 and associated parameters 125 input by the user using the graphical user interface 110, a model of the market under study is constructed in the form of a market model data structure 120. The market model data structure 120 is sent for processing to the profit maximization engine 170. The profit maximization engine 170 is located at the back end (figuratively speaking) of the software 100. Results from processing at the profit maximization engine 170 are gathered from a results database 190 and may be displayed by the graphical user interface 110 in the form, for example, of user-configurable dynamic charts 195 or tweened animations or movies.

Also shown at FIG. 2 are a project manager 105, a model compiler 130, and a multiprocessor manager 180.

The project manager 105 manages files organized by project and comprising market model data structures 120 and results databases 190 in the context, for example, of a typical software licensing scheme in which multiple users, each respectively affiliated with an institution licensed to use the software 100 and each respectively having a username and password, may be working on multiple market simulator/optimizer projects.

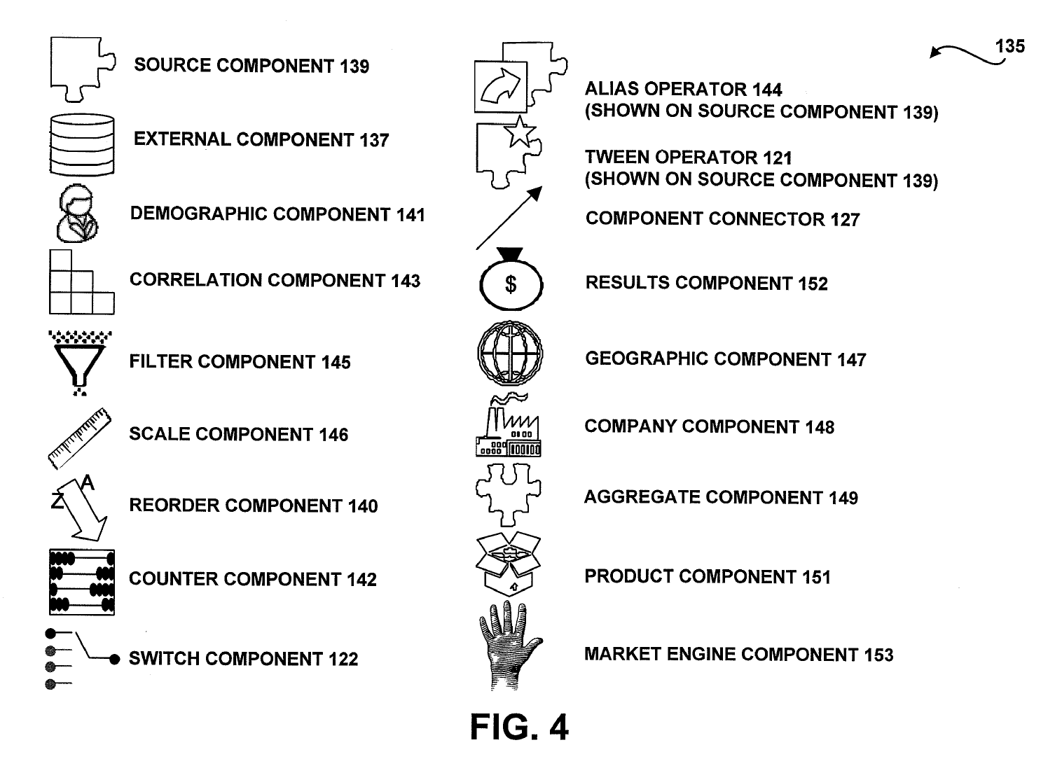

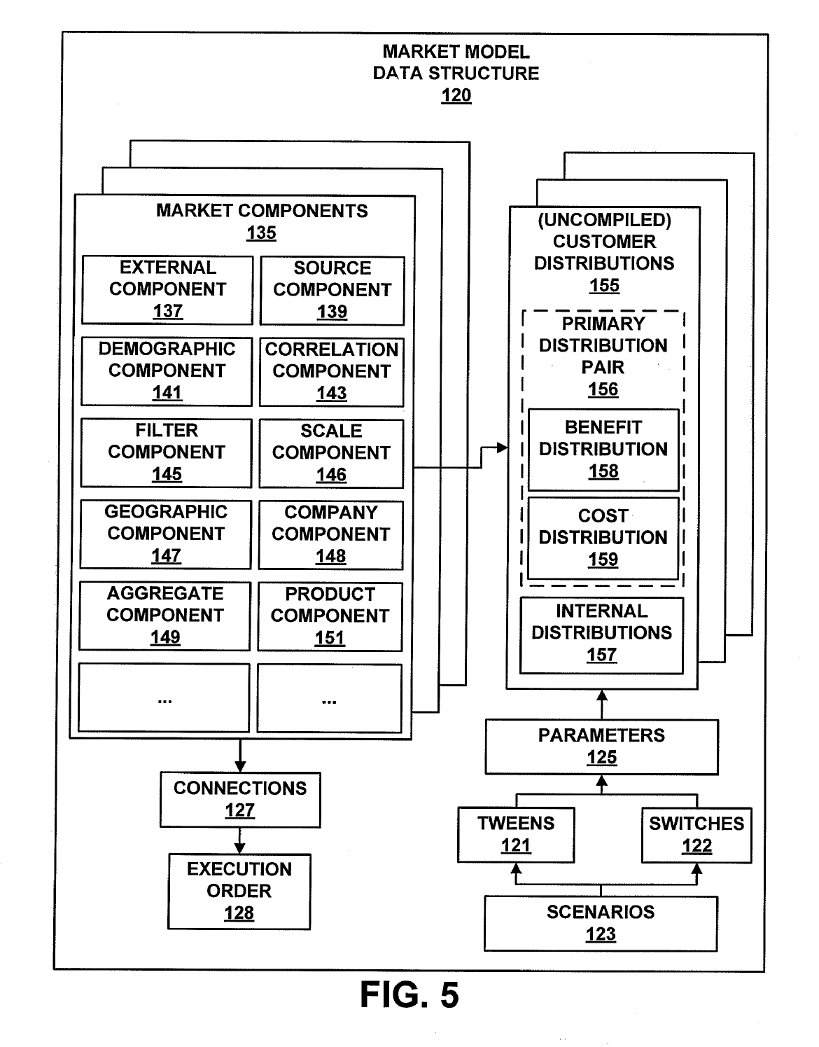

The model compiler 130 is responsible for checking the integrity of the sector diagram 115, and of the market model data structure 120 associated with the sector diagram 115, to ensure that the market model reflected in the sector diagram 115 is sensible and is capable of being processed by the profit maximization engine 170. Exemplary rules for integrity checking are mentioned in the description of the market component 135 given with reference to FIG. 4, and such rules are represented at FIG. 5 by the functional blocks labeled as connections 127 and execution order 128.

In the event that the software 100 has been developed so as to be thread-safe, the multiprocessor manager 180 preferably allows the profit maximization engine 170 to run in parallel on multiple processors 12 (this is the situation envisioned in the embodiment shown in FIG. 2). In the event that the software 100 is thread-unsafe, the software 100 would preferably be run on a single processor 12 with the timeline execution order 128 under strict control by the user. Note that there is no particular objection to running the software front end and the software back end on the same processor. Moreover, there is no particular objection to running the software back end on multiple processors, e.g., on a server machine or a cluster of server machines, at one site connected by way of a network to a different site at which the software front end is running on a different processor, e.g., on a client machine. Moreover, there may be many such client machines delivering market simulation services to a number of users at the respective client machines.

During the course of running the software 100, various messages 185, alerts 186, and signals 187 may be presented to the user as needed by way of the graphical user interface 110.

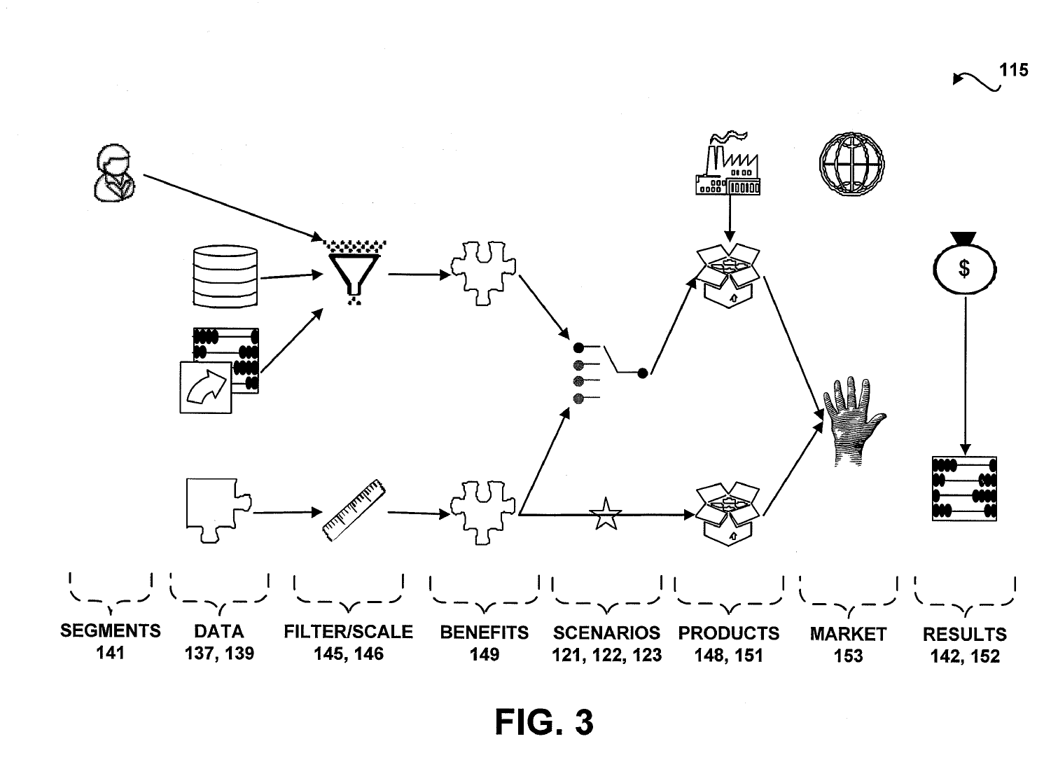

FIG. 3 shows an example of a sector diagram 115. At the sector diagram 115 shown in FIG. 3, a user can drag-and-drop or otherwise arrange icons representing various market component or operator functionalities within a drawing-canvas-like window (hereinafter “drawing canvas” but also referred to as “market model studio”) to create an iconic map that symbolically represents the market under study. For this reason, the sector diagram 115 is also referred to herein as a “market map.”

Where the user has defined multiple sectors, each of which is associated with its own sector diagram 115, a sector selection panel or other such tool might be used to allow the user to load the desired sector diagram 115 into the drawing canvas. Although, as will be seen below, the product definition pipeline within a sector diagram 115 typically culminates in a market engine component 153, signifying handoff to the profit maximization engine 170 at the right side of the sector diagram 115, this need not always be the case, as every sector diagram 115 need not necessarily have its own market engine component 153. For example, a user might group together a plurality of market components 135 that are related to a particular market driver on one sector diagram 115, and use an alias operator 144 to create an alias of a market component 135 so that the market components 135 associated with that market driver can be linked to a market engine component 153 on a separate sector diagram 115. An alias on a second sector diagram 115 of a results component 152 on a first sector diagram 115 may also be used to facilitate manipulation of those results for charting or further analysis, for example.

Market components 135 are the set of building blocks that define the market model being simulated by the user. Market component icons 135 are visual representations of various aspects of real-world market. For example, a source component 139 may be used to represent the benefit that each of a plurality of virtual customers enjoys from a given product 151. For instance, the benefit to a virtual customer in purchasing a cola beverage may range between $4.00 and $0.50.

An exemplary set of market component icons 135 and their names are shown at FIG. 4. Icons such as those shown at FIG. 4 may be made available to the user in the form of a market component toolbox. Such a market component toolbox might sit within the drawing canvas so as to provide the user with quick access to all of the market component icons capable of being placed within the sector diagram 115 that is currently loaded into the drawing canvas. In addition, aliases 144 for one or more of the market component icons might similarly be made available to the user in the form of an alias component toolbox. For example, a single common toolbox area might be employed, the user clicking a suitably marked tab or label to toggle the common toolbox between a state in which market component icons are displayed and a state in which market component alias icons are displayed. In one embodiment, icons appearing in the market component toolbox or alias component toolbox might be capable of being dragged (or click-and placed) into the sector diagram 115 that is currently loaded into the drawing canvas.

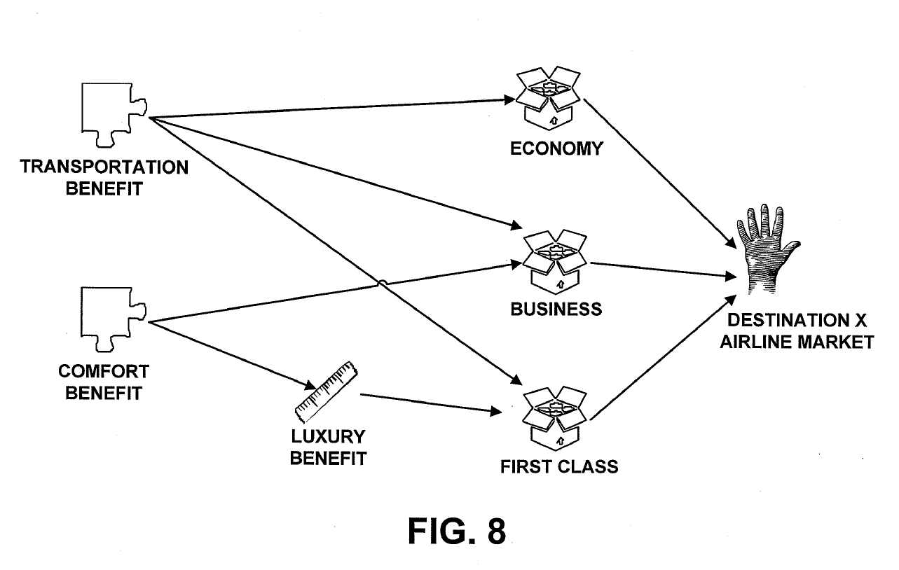

With simultaneous reference to FIGS. 3 and 4, in one embodiment, a user can drag-and drop different types of market components, such as a source component 139 or a demographic component 141, from such a toolbox onto the drawing canvas. The user can use component connectors 127 to connect upstream components to downstream components along one or more product definition pipelines representing the logical flow necessary to define the respective products 151 competing in the market under study. Where required, parameters 125 associated with one or more of the market component icons 135 can be input by the user by way of dialog boxes. Such dialog boxes might be accessed, for example, by right-clicking on a market component icon 135, selecting “Properties”, and clicking on any of a number of tabs, such as a Format tab, a Set tab, a Cost tab, a Data tab, a Store tab, and an Alert tab. Such a market model studio provides a visual way to edit the parameters 125 (and hence the market characteristics) of each such market component 135 to simulate the various drivers of the market in question. As will be described in more detail below with reference to FIGS. 8 through 12, in accordance with one embodiment a user would typically tune the market model until the simulation reflected the observed market characteristics. Once the market model has been satisfactorily tuned to reflect observed market characteristics, the user could use the market model as an easy-to-use visual platform upon which to, for example, test market strategies, react to competitive initiatives, and optimize price to maximize profit.

While more detailed description of the various market component icons 135 appearing in the sector diagram 115 of FIG. 3 is given below, a brief overview of the market model shown in FIG. 3 follows. At the upper branch of the product definition pipeline shown in the drawing, benefit (partworth) data from a plurality of sources 137, 139 converge on a funnel-shaped filter component 145 and are subjected to filtering based on demographic information 141 modeling market segmentation, the data from the plurality of sources being in the process mixed and matched to generate a virtual customer distribution that is then aggregated to model a benefit 149 that is input at one contact of a switch component 122. At the lower branch of the product definition pipeline shown in the drawing, internally generated partworth data 139 having normal (Gaussian) or other such distribution shape and with desired mean and standard deviation is scaled 146 to model desired correlation before being aggregated as a benefit 149 that is input to another contact of the switch component 122. The switch component 122 allows comparison of discrete differences in levels in similar fashion as Conjoint analysis, but unlike Conjoint analysis is here done with use of virtual customers. The tween star 121 signifies that a particular scenario is to be tweened, i.e., one or more parameters 125 are to be varied in continuous or pseudo-continuous fashion within a range defined by the user so as to permit the simulation to run as an animation or movie to better illustrate dynamic effects of changes to the parameter(s) 125 in question. Products 151 toward the right side of the drawing feed into a market engine component 153 signifying handoff to the profit maximization engine 170, with a price-competitive or non-competitive group being modeled by means of a company component 148, here signifying products not in price competition due to common ownership or other such non-competitive affiliation, and with geographic information corresponding to any necessary lost benefit due to distance from distribution channel being modeled by means of a geographic component 147. Placeholders containing results 142, 152 of the profit maximization engine 170 can be used to generate charts or can be fed back into the market model, as is the case with the results component alias present at mid-height on the left side of the drawing.

Each market component 135 can be configured by the user through a set of parameters 125, these parameters 125 representing the set of variables that define each market component 135. In one embodiment, such parameters 125 can be configured through the Set tab and the Cost tab within a Properties window of the selected market component 135. For example, in one embodiment, the “Distribution Type” (e.g., Normal Distribution), “Mean” (e.g., 100.00) and “Standard Deviation” (e.g., 20.00) are three parameters 125 that can be defined by the user within a source component 139. Tweenable parameters are parameters that can be systematically changed along a tween timeline. In one embodiment, most floating point number parameters and Boolean parameters would be tweenable. In the example above, only the mean and standard deviation would preferably be tweenable; it would not make much sense for a user to systematically change the type of distribution (normal, Poisson, Bernoulli, etc.) along the tween time line.

At the exemplary market model depicted in the sector diagram 115 shown in FIG. 3, the logical flow of the product definition pipeline generally moves from upstream market components to downstream market components, and from independent market components to dependent market components, as one goes from left to right in the drawing. Here, upstream and downstream refer to relative position in flow sequence as determined by an execution order 128. Here, an independent market component is a market component that does not depend upon any upstream market component, and thus can be calculated first in the execution order 128. Typical examples of independent market components might, in one embodiment, include source components 139 (with no upstream component), demographic components 141 (always), external components 137 (always), correlation components 143 (with no upstream component). A dependent market component is a market component that depends upon updated output from one or more upstream components before the dependent market component can itself be updated. Typical examples of dependent market components in such an embodiment might, in one embodiment, include aggregate components 149, product components 151, filter components 145, reorder components 140, scale components 146, source components 139 (with one or more upstream components), correlation components 143 (with one or more upstream components), and market engine components 153. As suggested above, the execution order 128 is preferably such that independent market components are calculated first, followed by dependent market components. An illegal circular reference will preferably be found to exist if a dependent market component depends upon itself.

In the sector diagram 115 shown in FIG. 3, from the direction of the arrowheads of the component connectors 127, it can be seen that arrangement of market components is generally such that flow is from upstream to downstream as one goes from left to right in the drawing, typically culminating in one or more product components 151 before arriving at a market engine component 153 at the far right in the drawing. Because arrival at the market engine component 153 signifies that product definition is complete, the market engine component 153 may be thought of as a connection between the software front end and the software the back end, or as a trigger that causes the completed market model data structure 120, created by the user with assistance from the graphical user interface 110, to be handed off to the profit maximization engine 170 after having been compiled (aggregated) by the model compiler 130. For this reason, it is generally the case that only product components 151 and/or aliases 144 of product components 151 are connected to market engine components 153.

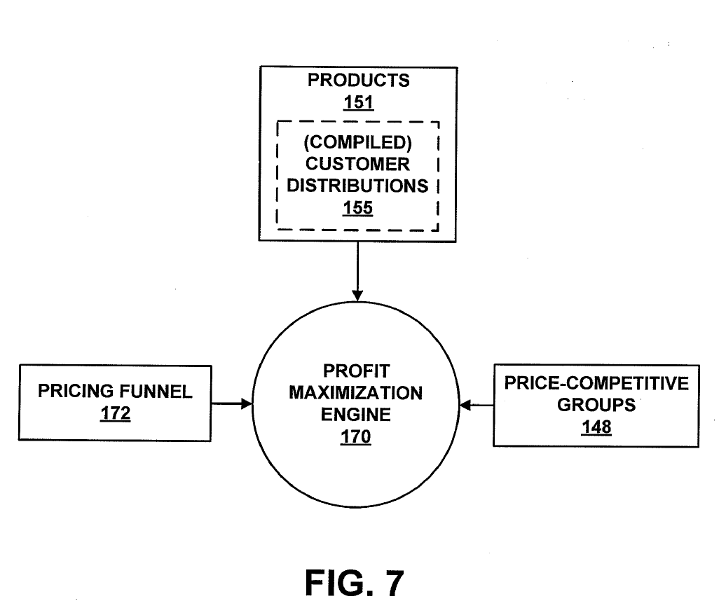

Returning briefly to FIG. 2, it can be seen that input from a user by way of a graphical user interface 110 using market component icons 135 as shown in FIG. 4 to create a sector diagram 115 as shown in FIG. 3 serves as basis for a market model data structure 120 that is handed off to a profit maximization engine 170 for processing. FIG. 5 shows an example of such a market model data structure 120. FIG. 7 shows an example of such a profit maximization engine 170 and functional blocks associated therewith.

Moreover, with simultaneous reference to FIGS. 3 through 5 and FIG. 7, note that like reference numerals are used for like functional elements, even though, consistent with evolution of the market model as one goes from the graphical user interface 110 at the software front end to the profit maximization engine 170 at the software back end, such reference numerals may at times refer to icons at the graphical user interface 110, may at times refer to data sets within the market model data structure 120, and may at times refer to inputs to the profit maximization engine 170.

Referring to FIG. 5, the market model data structure 120 in the present exemplary embodiment comprises data sets corresponding to market components 135 such as those represented by icons in the list shown in FIG. 4. Due to space limitations, only some exemplary market components 135 from among the list at FIG. 4 are shown in FIG. 5, but optional presence of others is suggested by ellipses in the drawing. Moreover, depending on the market being simulated, one or more of the market components 135 shown in FIG. 5 may be omitted.

As can be seen in FIG. 5, the market model data structure 120 furthermore comprises data sets corresponding to customer distributions 155. As indicated at FIG. 5, a customer distribution 155 typically comprises a primary distribution pair 156 and may further comprise one or more additional distributions, these additional distributions, when present, being referred to as internal distributions 157. The primary distribution pair 156 typically includes a benefit distribution 158 and a cost distribution 159 (see note regarding exceptions, below). A benefit distribution 158 contains values indicative of respective benefits to the multiplicity of virtual customer, and is similar to a partworth distribution as that term is used in the context of Conjoint analysis. A cost distribution 159 contains values indicative of respective costs associated with providing the respective benefits to the multiplicity of virtual customers.

Exceptions to the general rule, mentioned above, that the primary distribution pair 156 includes a benefit distribution 158 and a cost distribution 159 include circumstances in which special distributions take the place of the benefit distribution 158 and/or the cost distribution 159. For example, although it is in general possible to represent at least some types of demographic information in the form of a benefit distribution 158, a demographic component 141 will typically output a primary distribution pair 156 consisting of a demographic distribution containing demographic information in place of the benefit distribution 158 (e.g., such demographic information might be a text string indicating whether a virtual customer is “male” or “female”), and a zero distribution containing all zeroes as the cost distribution 159. The primary distribution pair 156 output by the counter component 142, in which a counter distribution may take the place of the benefit distribution 158, represents another such exception. The primary distribution pair 156 output by the results component 152, in which a results distribution may take the place of the benefit distribution 158, represents another such exception.

For purpose of carrying out simulations, the market simulator/optimizer of the present embodiment employs a multiplicity of virtual customers. For example, there might be 1,000 virtual customers in one working example of a market simulator/optimizer in accordance with the present invention. In such a working example, the customer distributions 155 would include data corresponding to the full set of 1,000 virtual customers, and the virtual available market would be said to comprise 1,000 virtual customers. The virtual available market represents the number of virtual customers within the market model. It would be typical for a user to select a small virtual available market (say 1,000 virtual customers) when first setting up the model, and a larger virtual available market (say 10,000 virtual customers) when generating final results. A small virtual available market helps ensure the market model runs quickly. A large virtual available market helps ensure that customer outliers do not significantly impact the results.

What is meant by a distribution in this context is the collective data associated with the set of all virtual customers in the working example. That is, each individual virtual customer might have associated therewith data indicative of a benefit and a cost to that individual virtual customer for a given product feature. In such case, the set of all benefit values across the entire virtual customer base would collectively be taken to be a benefit distribution 158. Similarly, the set of all cost values across the entire virtual customer base would collectively be taken to be a cost distribution 159.

In one embodiment, benefit distributions 158 can be added to other benefit distributions 158, and cost distributions 159 can be added to other cost distributions 159. As described in more detail below, in some embodiments, the profit maximization engine 170 will select the best product 151 for each virtual customer to purchase based upon the maximum consumer surplus the product 151 will provide to the virtual customer. If the consumer surplus is less than zero for all products 151, then the profit maximization engine 170 would determine that the virtual customer would not purchase anything.

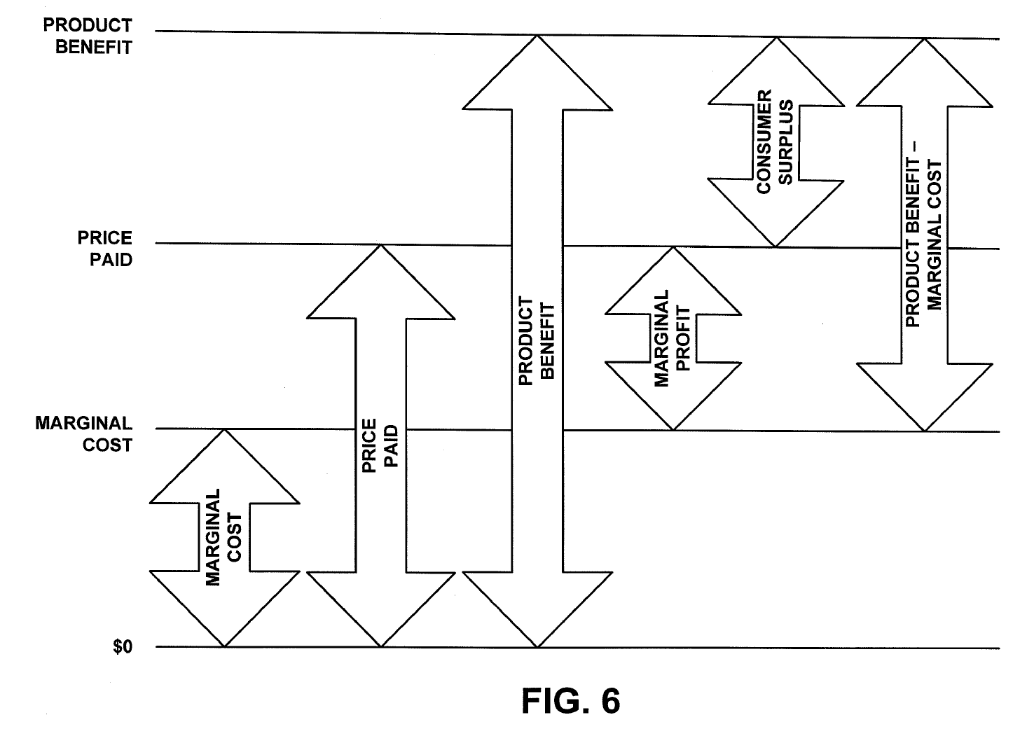

Referring to FIG. 6, this is a diagram schematically illustrating the relationship between cost, price, benefit, and consumer surplus, these being used by the profit maximization engine in one embodiment of the present invention. Products provide customers with benefits. The consumer surplus that customers enjoy is the difference between the benefit provided and the price paid. Stated another way, consumer surplus is equal to the benefit of the product minus the price to purchase the product. The companies that make the products incur marginal costs. Company profits are the difference between the price they receive for the products and their marginal costs. Note that except where otherwise clear from context, all costs referred to herein are preferably understood to be marginal costs.

The market simulator/optimizer of the present invention relies upon a number of customer distributions which describe the likes and dislikes of every customer in the market for every feature offered by every product in that market. Within each customer distribution, every customer is allocated a utility for each feature expressed in dollars (that is, each customer is allocated a “dollarmetric” utility). For example, Customer 1 might value the brand of a particular beverage at $2.00 while Customer 2 might only value the brand at $1.00. Thus, all else being equal, Customer 1 would pay up to $2.00 more for the branded beverage than for the identical unbranded equivalent. Think of buying a glass of bottled water in a restaurant where the waiter gives you a choice between a no-name brand of bottled water and branded bottled water. Because the water comes ready poured in the glass, and because both bottled options were otherwise equivalent, the only difference between the two options is the value of the brand. Conjoint analysis is related to the market simulator/optimizer of the present invention because it allows a researcher to parse the value of products into their constituent features. For Conjoint analysis, customer distributions are referred to as a “partworth distributions.”

The cumulative cost distribution 159 is the increasing variable cost of producing a product 151 along the product definition pipeline. The cumulative cost represents the sum of upstream costs. Many market components 135 can contribute to total cost. For example, a source component 139 may add a benefit to the product 151 but may also incur an incremental cost to the company. In some cases, the cost may even vary by virtual customer. This may be the case, for example, if a company promotes a product 151 to just a smaller demographic within the virtual available market. There is no particular objection to using an aggregate component 149 to aggregate together all upstream cost distributions 159 into a cumulative cost distribution 159. However, it would not make sense to aggregate a benefit distribution 158 with a cost distribution 159 unless a reorder component 140 were first used to swap the distributions.

As mentioned above, the benefit distributions 158 of the present invention are similar to the partworth distributions employed in Conjoint analysis. Briefly, Conjoint analysis provides the process by which products can be mathematically broken out into their constituent benefits using a statistical process. In the language of Conjoint analysis, the benefit distribution 158 is the set of partworth values for respective customers. A partworth value is the value a customer places upon just one particular product feature. Each virtual customer would have a different partworth for each product feature. In one embodiment in accordance with the present invention, partworth values can be determined through Conjoint analysis or can be estimated through an examination of vertical differentiation and horizontal differentiation relative to other product features, as will be described below with reference to FIGS. 8 through 12.

Although in the present embodiment, the model compiler 130 performs aggregation or compiling of the uncompiled customer distributions 155 associated with the various individual market components 135 in the market model data structure 120 at the time that the compiled customer distributions 155 associated with product components 151 are to be handed off by the market engine component 153 to the profit maximization engine 170, it is nonetheless useful to think of the customer distributions 155 as being in successive stages of aggregation as one moves along the product definition pipeline toward the market engine component 153. It is therefore useful to think of the benefit distributions 158 associated with various individual market components 135 as accumulating as one goes from upstream to downstream to form increasingly cumulative benefit distributions 158. Similarly, regardless of when aggregation of cost distributions 159 is actually performed, it is useful to think of costs as accumulating at each successive stage in the product definition pipeline to form increasingly cumulative cost distributions.

In this way, the customer distributions 155 may be thought of as being transformed as processing proceeds from upstream to downstream as defined by arrangement of market component icons 135 in the form of a market map such as is shown by way of example in the sector diagram 115 of FIG. 3 together with any parameters 125 associated therewith as entered by the user. Market component icons 135 can therefore be thought of either as operators capable of transforming customer distributions 155 in various ways or as themselves representing customer distributions 155 in various stages of accumulation of conditions and parameters for eventual processing by the profit maximization engine 170. That is, the market component icons 135 shown in the sector diagram 115 of FIG. 3 are, in general, each associated with their own set of customer distributions 155, these customer distributions 155 evolving as they are transformed in correspondence to processing as defined by the market map and associated parameters 125.

In the present embodiment, the customer distributions 155 may, for example, be stored in the form of arrays of doubles, longs, integers, and/or strings. If there are 1,000 virtual customers being simulated, there might, for example, be 1,000 elements in each such customer distribution array. In such case, an array offset index n might, for example, represent the nth individual virtual customer. For example, Customer #176 would in such case have benefit and cost information stored at offset 176 in a whole sequence of customer distribution arrays representing the entire product definition pipeline.

In general, a market component 135 will receive input from one or more upstream market components 135 and will deliver output to one or more downstream market components 135. That is, as one proceeds along a product definition pipeline as shown by way of example in the sector diagram 115 of FIG. 3, benefit distributions 158 output from upstream market components 135 generally serve as input for benefit distributions 158 of downstream market components 135, and cost distributions 159 output from upstream market components 135 generally serve as input for cost distributions 159 of downstream market components 135. What happens at a typical market component 135 located at an arbitrary point intermediate in the product definition pipeline is that customer distribution(s) 155 output from market component(s) 135 upstream therefrom serve as input for the market component 135 in question, internal distribution(s) 157 being added to or otherwise used to transform the input customer distribution(s) 155 in question so as to generate output customer distribution(s) 155 that will then serve as input for market component(s) 135 downstream therefrom. A product component 151 at the end of a product definition pipeline will therefore comprise an accumulated (i.e., cumulative) benefit distribution 158 and an accumulated (i.e., cumulative) cost distribution 159. Except where otherwise clear from context, benefit distributions 158 as used herein refer to benefit distributions 158 as output by market components 135, and cost distributions 159 as used herein refer to cost distributions 159 as output by market components 135, but where emphasis is desired an adjective such as “output” may be used for clarity (e.g., output benefit distribution 158, output cost distribution 159, etc.). When it is desired to emphasize that a benefit distribution 158 or a cost distribution 159 serves as input for a market component 135, an adjective such as “input” may be used for clarity (e.g., input benefit distribution 158, input cost distribution 159, etc.). Note that some market components 135 may have no input benefit distribution 158 and/or no input cost distribution 159. Moreover, some market components 135 may have no internal distribution 157.

As previously mentioned, the model compiler 130 is responsible for enforcing rules governing what constitutes legal/illegal arrangement of market component icons 135 (e.g., with respect to what upstream/downstream connections are allowed and so forth). At FIG. 5, the functional blocks marked connections 127 and execution order 128 represent two aspects of how the software 100 ensures that arrangement of market component icons 135 by a user by way of the graphical user interface 110 will result in a market model capable of sensible processing by the profit maximization engine 170. In addition, the software 100 has rules governing what types of customer distributions 155 are permitted/required for which market component icons 135. The software 100 also has rules governing how customer distributions 155 are transformed in going from upstream to downstream between various pairs of respectively different market component icons 135.

Detailed explanations of respective market components 135, and representative rules for interconnection with other market components 135, are given below in accordance with one embodiment of the present invention.

Typically, the source component 139 is the first type of market component 135 used in the market model. Source components 139 typically sit on the left side of the drawing canvas (by way of example, see the sector diagram 115 shown in FIG. 3). Source components 139 typically have few (if any) upstream connections. In some embodiments, source components 139 generate benefit distributions 158 describing customer preferences for various product features (in Conjoint analysis, these distributions would be called “partworth” distributions). A user would typically use a source component 139 to describe the benefit that each virtual customer in the virtual available market would enjoy. Like many market components, source components 139 may, moreover, generate cost distributions 159 indicating the cost of supplying the feature to the market. For instance, a certain product feature (represented as a benefit distribution 158) may only be available to a user after the company spends resources in providing the feature (represented as an internal cost distribution). This internal cost distribution would be added to any input cost distributions coming from upstream components, if present, to generate an output cost distribution 159. A normal (i.e., Gaussian) distribution would be one exemplary distribution shape that could be employed by a source component 139 in generating a benefit distribution 158 and/or a cost distribution 159. In some embodiments, there are other types of distribution shapes that can be generated. For example, in some embodiments, the source component 139 might alternatively or in addition be able to generate benefit and/or cost distributions having shapes conforming to uniform, Bernoulli, binomial, Poisson, patterned, and/or sinusoidal distributions. For example, a source component 139 may produce a benefit distribution 158 that has a normal (Gaussian) distribution with a given mean and standard deviation. Or, for example, a source component 139 may produce a benefit distribution 158 that has a patterned shape corresponding to a known set of customer demographics. In some embodiments, benefit distributions of Gaussian or other such distribution shape are statistically generated by a source component 139 or other market component 135 such that respective benefits to respective virtual customers conform to a random or pseudorandom distribution. Moreover, in some embodiments, a distribution so generated may admit of characterization in terms of mean and correlation values relative to one or more other benefit distributions. Moreover, in some embodiments, the same may apply to generation of cost distributions. Depending on the distribution shape in question, a user would be able to enter whatever parameters 125 are necessary to define the benefit distribution 158 and/or cost distribution 159. In some embodiments, a user may, for example, specify parameters 125 for a source component 139 by right-clicking on the source component icon 139, selecting “Properties”, and clicking on a Set tab and/or a Cost tab. In some embodiments, an alias operator 144 permits creation of a source component alias that is logically linked to its parent source component 139. Such a source component alias would inherit the primary distribution pair 156 from its parent source component 139 but inherit none of the internal distributions 157. In such an embodiment, the source component alias would not be capable of generating a customer distribution 155 in the same way that the parent source component 139 can; instead, a source component alias would be capable of summing its primary distribution pair 156 with primary distribution pairs 156 from upstream components.

One or more external components 137 may be associated with any number of customer distributions or portions thereof to be imported into the software 100 from one or more external data tables or other such external data sources. For example, a user may employ external software such as Excel® (registered trademark of Microsoft Corporation of Redmond, Wash., USA) or SPSS® (registered trademark of SPSS Inc. of Chicago, Ill., USA) to generate partworth data and/or customer distributions that are then imported into the market simulator/optimizer 100. A user may alternatively or in addition import partworth data from a Conjoint analysis study. Such external data is introduced into the market simulator/optimizer 100 through use of one or more external components 137. Data associated with an external component 137 may come from the user's local machine or other such location that is external to the software 100. A user may, for example, specify the location of the source of the external data by right-clicking on the external component icon 137, selecting “Properties”, and clicking on a Set tab. Data associated with an external component 137 may, for example, be in table format such that each row corresponds to a virtual customer in the virtual available market. In some embodiments, an alias operator 144 permits creation of an external component alias that is logically linked to its parent external component 137. In such an embodiment, the external component alias would not itself be capable of uploading customer distributions from an external file in the same way that the parent external component 137 can; instead, at the external component alias, the user would define which customer distribution 155 within the parent external component 137 is to serve as data source for the benefit distribution 158, and which customer distribution 137 within the parent external component 137 is to serve as data source for the cost distribution 159.

Customer segmentation can be modeled through the use of the demographic component 141. Use of one or more demographic components 141 provides a descriptive way (i.e., using string, Boolean, and/or integer value(s)) to distinguish customers from each other based on one or more demographic or other such attribute(s). For example, a demographic component 141 might be used to categorize some customers as “power users” and other customers as “casual users” of a product. As such, demographic components 141 have the capability of defining a particular type of customer demographic information applicable to all or any subset of the virtual customers in the market. Such customer demographic information might, for example, be stored in association with the benefit distribution 158. Because all market component 135 in a given sector diagram 115 operate based on a common set of virtual customers, with information applicable to respective virtual customers being stored at corresponding respective locations (e.g., each virtual customer might correspond to a particular row of an array), it is possible in some embodiments for demographic information to be input to the software 100 merely by placing a demographic component 141 icon in the blank space in the margin of the sector diagram 115, without connecting the demographic component 141 to any other market component 135. However, where a component connector 127 is used to connect a demographic component 141 to one or more other market component 135, the demographic component icon 141 will typically appear at the head of the product definition pipeline (left side of the sector diagram 115 in FIG. 3). To the extent that it is believed that customer demographics do not contribute to the cost of a product, it will likely be the case, at least in some embodiments, that the demographic component 141 does not have a cost distribution 159 associated therewith. For example, the user may define the number of high-end, mid-end, and low-end virtual customers within the market by setting respective percentages for each. It is preferred in one embodiment that demographic components 141 have no upstream components, but downstream components are allowed. A user might, for example, use a filter component 145, described below, to define a set of customer demographics based on upstream components. In some embodiments, an alias operator 144 permits creation of a demographic component alias that is logically linked to its parent demographic component 141. In one embodiment, such a demographic component alias would inherit the benefit distribution 158 from its parent demographic component 141. In such an embodiment, the demographic component alias would not be capable of generating customer demographics in the same way that the parent demographic component 141 can; instead, a demographic component alias would be capable of summing its output distribution with input distributions from upstream components. In some embodiments, the parent demographic component 141 would not have a cost distribution 159, but a demographic component alias would have a cost distribution 159 so as to permit formation of a primary distribution pair 156. By default, the cost distribution 159 of such a demographic component alias would be empty (that is, it will be set to the zero distribution), but if there are upstream components connected to the demographic component alias then their cost distributions 159 would be summed together and stored in the cost distribution 159 of the demographic component alias.

The correlation component 143 will generate customer distributions 155 equivalent to as many as, say, ten source components 139. Whereas use of the source component 139 to generate ten customer distributions 155 individually would result in ten customer distributions 155 that each had no correlation with any of the others, use of the correlation component 143 to generate ten customer distributions 155 permits the user to specify the amount of correlation that each customer distribution 155 should have relative to each of the others. Correlation components 143 have the capability of generating multiple benefit distributions 158, each of which has an associated cost distribution 159, from a set of parameters 125 specified by the user by right-clicking on the correlation component icon 143, selecting “Properties”, and clicking on a Set tab and a Cost tab, for example. The correlation component 143 can use an upstream market component 135 to provide a reference starting point for purposes of generating output benefit distributions 158 having varying degrees of correlation with respect thereto. Benefit distributions 158 generated by the correlation component 143 may be in the shape of a normal (Gaussian) distribution, for example, having mean and standard deviation as specified by the user. Each of the benefit distributions 158 so generated might be related to each of the other benefit distributions 158 so generated in the manner specified by the user in a correlation matrix accessible by way of the aforementioned Set tab, for example. As one example of how the correlation component 143 might be used, a correlation component 143 may be used to generate a number of related micro-level market drivers from a single macro-level market driver. In one embodiment, the correlation component 143 is similar to the scale component 146, described below, notable differences between the two including the fact that whereas the scale component 146 might be capable of generating only one output customer distribution 155 the correlation component 143 might be capable of generating as many as, say, ten output customer distributions 155 of potentially varying degrees of correlation, and the fact that whereas the scale component 146 might be capable of modeling both horizontal and vertical differentiation, described below, the correlation component 143 might be capable•of modeling only horizontal differentiation. In some embodiments, an alias operator 144 permits creation of a correlation component alias that is logically linked to a parent correlation component 143. In such an embodiment, the correlation component alias would not be capable of generating numerous customer distributions 155 in the same way that the parent component can; instead, the user would define which primary distribution pair 156 within the parent correlation component 143 would be linked to the correlation component alias.

Filter components 145 perform IF-THEN-ELSE operations on the customer distribution 155 output from upstream components. For example, a filter component 145 might be used to transform a customer distribution 155 such that IF a virtual customer in a customer distribution 155 from an upstream market component 135 is in the “Heavy Industry” segment of the market (as defined by a demographic component 141) THEN that virtual customer would receive a higher benefit from a product's “Power” feature ELSE that virtual customer would receive a lower benefit from the same feature. Filter components 145 have the capability of setting or mixing customer distributions 155 from upstream market components 135 depending on the outcome of an IF-THEN-ELSE operation. For example, a filter component 145 may be used to ensure that an upstream benefit distribution 158 satisfies a certain threshold for each virtual customer. As another example, a filter component 145 may be used to define a set of customer demographics based upon upstream components. In some embodiments, an alias operator 144 permits creation of a filter component alias that is logically linked to a parent filter component 145. Such a filter component alias would inherit the primary distribution pair 156 from the parent filter component 145 but inherit none of the internal distributions. In such an embodiment, the filter component alias would not be capable of filtering upstream customer distributions 155 in the same way that the parent component can; instead, the filter component alias would be capable of summing its primary distribution pair 156 with primary distribution pairs 156 from upstream components.

The scale component 146 is used to scale, or adjust, the benefit of a particular feature. For example, if most customers in a market agree that a feature in a particular product is better than the equivalent feature in a competitive product, then the market component 135 describing that benefit could be scaled up for that product. Here, the phrase “most customers” used in the example given would be significant for proper modeling of the benefit of that product feature. The more disagreement there is among customers as to the benefit of a particular feature across competitors, the less correlation the customer distributions 155 describing that benefit will have. Scale components 146 have the capability of scaling the input distribution from an upstream component in accordance with parameters set by the user (in some embodiments, scale component 146 is allowed to have only one upstream component). In some embodiments, the scale component 146 also allows the user to specify the degree of correlation between the input distribution and the output distribution. For example, where the customer distribution 155 output by an upstream component is a normal (Gaussian) distribution, the user might use a scale component 146 to shift the mean of that distribution, or the user might transform the customer distribution 155 so that it has a different standard deviation. In some embodiments, the user might apply the scale component 146 to improve a given benefit distribution 158 within another market component 135. And because improving a benefit may involve additional cost on behalf of the company, the user may also specify the additional cost to be added to the cost distribution 159 within the product definition pipeline. In some embodiments, an alias operator 144 permits creation of a scale component alias that is logically linked to its parent scale component 146.

Such a scale component alias would inherit the primary distribution pair 156 from the parent scale component 146 but inherit none of the internal distributions 157. In such an embodiment, the scale component alias would not be capable of scaling a customer distribution 155 in the same way that the parent scale component 146 can; instead, a scale component alias would be capable of summing its primary distribution pair 156 with primary distribution pairs 156 from upstream components. In some embodiments it is the case that a scale component 146 can receive input from only one upstream component, but a scale component alias can receive input from an unlimited number of upstream components.

The reorder component 140 is capable of reordering a customer distribution 155 by, for example, sorting the data within the customer distribution 155 (the primary distribution pair 156 can be sorted by input benefit distribution 158 or input cost distribution 159), shifting the data (the primary distribution pair 156 can be shifted by a user-defined offset), or swapping the benefit distribution 158 with the cost distribution 159. Because it is preferred that the position of each virtual customer in the market model data structure 120 be consistent throughout the model (that is, Virtual Customer#105 is preferably always located at position 105 in every customer distribution 155) the reorder component 140 would typically only be used for advanced operations or for reviewing the customer distributions 155. That is, because the reorder component 140 may upset the universal consistency of the customer ID ordering within a customer distribution 155, it should only be used with care and understanding. The reorder component 140 is typically not used to simulate market trends but may be used to evaluate the data within a product definition pipeline or the final results. In some embodiments, an alias operator 144 permits creation of a reorder component alias that is logically linked to its parent reorder component 140. Such a reorder component alias would inherit the primary distribution pair 156 from the parent reorder component 140 but inherit none of the internal distributions. In such an embodiment, the reorder component alias would not be capable of reordering (sorting, shifting, or swapping) a customer distribution 155 in the same way that the parent component can; instead, a reorder component alias would be capable of summing its primary distribution pair 156 with primary distribution pairs 156 from upstream components. In some embodiments it is the case that a reorder component 140 can receive input from only one upstream component, but a reorder component alias can receive input from an unlimited number of upstream components.

The counter component 142 is capable of incrementing or decrementing a counter depending upon whether certain conditions are met at the input customer distribution 155. As such, the counter component 142 can be used for a wide variety of purposes. For example, if a virtual customer selected the user's product during the previous simulation iteration, then that virtual customer may now be more “locked in” to using the product again during the next simulation iteration, and the counter component 142 could be used to reflect this. The counter component 142 may be useful when the user wishes to aggregate repeat sales of a product by virtual customer, model consumer loyalty, add a benefit based upon the virtual customer's familiarity with the product, subtract a benefit based upon the virtual customer's switching costs from one product to another, increase the benefit of a product as it progresses along a learning curve. In one embodiment, a counter component 142 could be given the ability to count up or down by a fixed value, or by the amount of the benefit or cost as listed for that virtual customer in the customer distribution 155. In one embodiment, a user might right-click on the counter component 142, select “Properties”, click on a Set tab, and use an IF-THEN-ELSE operation to specify under what conditions a counter is to be incremented or decremented. The counter component 142 will typically output a primary distribution pair 156 consisting of a counter distribution containing counter information in place of the benefit distribution 158 (e.g., such counter information might indicate how many times a product has been purchased by the virtual customer in question), and a zero distribution containing all zeroes as the cost distribution 159. Like the results component 152, the counter component 142 in some embodiments is unusual in that the counter distribution from a previous iteration time frame is made to carry forward into the next iteration time frame, thus allowing the user to specify a feedback loop from one iteration time frame to the next. Where this is the case, the market model will in general no longer be thread-safe. While feedback loops can be useful for modeling of market phenomena, the fact that the market model may becomes thread-unsafe means that time frames cannot be calculated out of order and cannot be calculated in parallel, e.g., using a multiprocessor. There is no particular objection to employment of a thread-unsafe model, but such models may therefore take longer to run. In some embodiments, an alias operator 144 permits creation of a counter component alias that is logically linked to its parent counter component 142. Such a counter component alias would inherit the benefit distribution 158 from its parent counter component 142. In such an embodiment, the counter component alias would not be capable of incrementing or decrementing a counter distribution in the same way that the parent counter component 142 can; instead, a counter component alias would be capable of summing its output distribution with input distributions from upstream components. In some embodiments, the parent counter component 142 would not have a cost distribution 159, but a counter component alias would have a cost distribution 159 so as to permit formation of a primary distribution pair 156. By default, the cost distribution 159 of such a counter component alias would be empty (that is, it will be set to the zero distribution), but if there are upstream components connected to the counter component alias then their cost distributions 159 would be summed together and stored in the cost distribution 159 of the counter component alias.

The switch component 122 is a useful tool for determining which set of features result in the most profitable product. As such, the switch component 122 can be compared to a simulator within a conjoint analysis study. That is, some embodiments of the market simulator/optimizer of the present invention can use switch components 122 to model attributes and levels in similar fashion as is done in conventional Conjoint analysis. In such case, switch components 122 might correspond to the “attributes” of Conjoint analysis, and the contacts being switched at each switch component 122 might correspond to the various “levels” (in the language of Conjoint analysis) that each attribute can assume. That is, each of a plurality of switch components 122 might be assigned a different attribute, the various upstream market component “branches” connected to each contact of each such switch component 122 representing the various levels for the attribute. In such case, the switch timeline might be used to find the optimal collection of levels for each attribute. Users may wish to experiment with the best combination of features to add to a product. For example, when choosing between the type of pool to add to a hotel chain, a user might wish to experiment between “No Pool”, “Outdoor Pool”, “Indoor Pool”, and so forth. An additional choice may be between “No Restaurant”, “Breakfast Bar”, and “Fancy Restaurant”. The Switch Component 122 allows the user to examine the profitability of each combination in the market; e.g., “No Pool”+“No Restaurant”; “No Pool”+“Breakfast Bar”; “No Pool”+“Fancy Restaurant”; “Outdoor Pool”+“No Restaurant”; and so forth. Switch components 122 have the capability of switching the primary distribution pair 156 from any number of upstream components into a single primary distribution pair 156 for output to the connected downstream components. In some embodiments, an alias operator 144 permits creation of a switch component alias that is logically linked to its parent switch component 122. In such an embodiment, the switch component alias would not be capable of switching the primary distribution pairs 156 from upstream components in the same way that the parent switch component 122 can; instead, a switch component alias would be linked to the primary distribution pair 156 that was switched by the parent switch component 122.

An alias operator 144 permits creation of aliases of the various market components 135. The market component 135 from which market component alias is created by means of the alias operator 144 is referred to herein as its parent component, and the market component alias is said to be linked to its parent market component. Component aliases are used to provide a logical connection between market components in those circumstances where a direct connection would be impractical, e.g., such as from one sector diagram 115 to another sector diagram 115. In one embodiment, only the primary distribution pair 156 from the parent component is available from within the component alias; none of the other customer distributions 155 from the parent component are linked to the component alias. In such an embodiment, component aliases would inherit data from their parent components but would not inherit the parent component's capabilities. For example, in such an embodiment, a filter component alias would itself not be capable of filtering any data. Instead, in some embodiments, component aliases are capable of summing customer distributions for the primary distribution pair from upstream components. As one example, the user may employ a component alias as one solution when a sector diagram 115 becomes overcrowded.

A tween operator 121 permits creation of a tween. In a tween, a market component parameter 125 is made to change systematically along a tween timeline. Many of the parameters 125 defining the various market components 135 can be changed dynamically to help the user simulate a real world dynamic in the market. In establishing a tween, a user may specify start and stop time frames for the parameter 125 being tweened, as well as the type of change that is to take place as the parameter 125 is tweened; e.g., whether the parameter 125 is to change in linear fashion or in exponential fashion. A tweened market component is represented on the drawing canvas by superposition thereon of a tween star 121. In one embodiment, most, but not all, parameters 125 that are of floating-point or Boolean type can be tweened. For example, in one embodiment, a user might be able to tween both the mean and standard deviation of a normal (Gaussian) distribution along the tween timeline, but would be unable to tween the distribution type (“distribution type” here referring to the shape of the distribution; e.g., Gaussian, Bernoulli, binomial, Poisson, etc.). The tween timeline contains all of the tweens within the market model. Tweens can be allocated to either the global scenario or to an individual scenario. During a simulation run, all of the tweens at the current tween time frame in both the global scenario and in the current individual scenario will be updated. If the same parameter is being tweened in both the global scenario and the individual scenario then it will be the individual scenario tween that will be updated. The tween timeline will finish when there are no more tweens to update along the timeline in both the global scenario and in the current individual scenario. For example, if the user has identified an emerging technology that will provide greater power efficiency to the products in the market, the user might estimate the technology to take two years to mature, during which time the benefit to customers would steadily increase and the additional marginal cost to manufacturers would steadily decline. In such a case, the user could then tween both of these parameters, which impact the benefit distribution 158 and the cost distribution 159, along the tween time line, and if there was a dispute over how long it would take for marginal costs to decline, then the user could introduce various scenarios 123; e.g., a “best case” scenario in which marginal costs would decline rapidly, and a “worst case” scenario in which marginal costs would decline slowly.

Component connectors 127 have the capability of connecting upstream components to downstream components. As can be seen at the icon list in FIG. 4, in one exemplary embodiment the component connector 127 may be represented by an arrow connecting market components 135 within a sector diagram 115. Note that information from some market components 135 can be associated with the simulation being defined by a sector diagram 115 merely by placing the market component 135 in question in the blank space in the margin of the sector diagram 115, without connecting the market component 135 in question to any other market component 135, as is the case with the geographic component 147 and the results component 152 that appear in the margin on the right side of the sector diagram 115 shown in FIG. 3. Although the counter component 142 is shown in the sector diagram 115 of FIG. 3 as being connected so as to be downstream from the results component 152, the results component 152 in the present embodiment need not necessarily be connected to any other market component 135 but may instead be placed by itself, such that it is unconnected to any other market component 135, in the margin or at any other suitable location on the sector diagram 115. Furthermore, although the counter component 142 is shown as being connected so as to be downstream from the results component 152, the counter component 142 in the present embodiment may be connected so as to be either upstream or downstream from any other appropriate market component 135. Although the demographic component 141 in FIG. 3 is shown as connected by means of a component connector 127 to a filter component 145, it is also possible in some embodiments for demographic information represented by a demographic component 141 to be associated with the simulation merely by placing the demographic component 141 in the blank space in the margin of the sector diagram 115, without connecting the demographic component 141 to any other market component 135. In most cases, the component connector 127 is merely a conduit for transferring the primary distribution pair 156 from the upstream component to the downstream component. However, in at least one embodiment, there are two special cases in which the user is able to define the specific primary distribution pair 156 to be carried by a component connector 127, this being done, for example, by right-clicking on the component connector 127 in question, selecting “Properties”, and clicking a Set tab to open a dialog box that allows the entry of the relevant parameters 125 for directly specifying a benefit distribution 158 and a cost distribution 159. One such special case is that of the external component 137, and the other such special case is the correlation component 143. As previously mentioned, the model compiler 130 is responsible for checking the integrity of the sector diagram 115. As indicated in the block diagram of FIG. 5, the connections 127 and execution order 128 defined by arrangement of the component connectors 127 between market components 135 as allowed by the graphical user interface 110 constitutes a part of this integrity check, the execution order 128 here being such that the processing along the product definition pipeline flows from upstream market components down to the market engine component 153. The execution order 128 is thereafter such as to allow processing to flow from the profit maximization engine 170 to any results components 152. Note that the user is not permitted to create a circular reference by connecting market components 135 together in a loop.

Results components 152, at least in some embodiments, act like component aliases in that their customer distribution 155 are sourced from elsewhere and in that they offer very limited functionality (like component aliases, results components 152 in some embodiments are only capable of adding customer distributions 155 from upstream market components 135). Results components 152 are associated with market engine components 153 and draw their customer distributions 155 from the results of the profit maximization engine 170. The profit maximization engine 170 will generate lots of results, only some of which are important to the user. The results component 152 is a way for the user to call out and examine what is important. For example, the user may wish to know the percentage of customers that consider the user's product within their top three product choices. In this case, the result components 152 can capture these top three choices and aggregate them as percentages for storage within the results database 190. The results component 152 may be useful when a user wishes to condense results into a single stored value; for example, a user might right-click on a results component 152, select “Properties”, and click on a Store tab in order to calculate such things as the average price paid for a product, the quantity of a product sold, the market share of a product, the percentage of time the product was a customer's second choice, and so forth. The results component 152 may also be useful when a user wishes to aggregate results from several results components 152; e.g., where a company offers several products in the same market, or offers the same product across several markets, it might be desired to add several result distributions together. The results component 152 may also be useful when a user wishes to reinject results back as part of a market dynamic. With respect to this last point, there are many situations where previous behavior of customers will impact their future behavior. For example, if a customer selects purchase of a product this period then that customer may experience switching costs that will prevent the customer from easily selecting a different product next period. The results distribution representing this period's purchase can be reinjected back into the model as an upstream market component contributing to the benefit of the purchased product for next period. A results distribution is capable of accumulating all of the customer distributions 155 generated by the profit maximization engine 170 for a particular market engine component 153. For example, a user may wish to aggregate a results distribution into a single stored value that represents a certain market statistic (such as market share). Exemplary types of results that can be stored in this way include the total marginal cost of the purchased product; the price paid for the purchased product; the product benefit of the purchased product; the marginal profit of the purchased product; the consumer surplus of the purchased product; the product benefit minus the marginal cost; the answer to the question ‘did a virtual customer buy any product?’; the name of the product purchased; the 1st choice product (note that the 1st choice product is not necessarily the same as the product purchased if the virtual customer did not buy any product, as might happen, for example, in the event that consumer surplus for the 1st choice product is negative); the 2nd choice product; the 3rd choice product; the nth choice product; and the last choice product. The results component 152 will typically output a primary distribution pair 156 consisting of a results distribution containing results information from a market engine component 153 in place of the benefit distribution 158. Note that, in some embodiments, only the benefit distribution 158 of the results component 152 is set by the profit maximization engine 170. In such embodiments, while the results component 152 may have a cost distribution 159, this cost distribution 159 is preferably only set by any upstream components connected to the results component 152. Like the counter component 142, the results component 152 in some embodiments is unusual in that the results distribution from a previous iteration time frame is made to carry forward into the next iteration time frame, thus allowing the user to specify a feedback loop from one iteration time frame to the next. Where this is the case, the market model will in general no longer be thread-safe. While feedback loops can be useful for modeling of market phenomena, the fact that the market model may become thread-unsafe means that time frames cannot be calculated out of order and cannot be calculated in parallel, e.g., using a multiprocessor. There is no particular objection to employment of a thread-unsafe model, but such models may take longer to run.

Geographic components 147 allow the user to model distribution channels for products in a market. Products are sometimes distributed through different geographic channels, and the locality of a product to each virtual customer can be either a benefit or a burden depending upon how far away the brick-and-mortar storefront is from that customer. As it is often the case that a product can be shipped to a customer, and this is often the case regardless of where the customer is living, shipping cost is typically used as a cap to limit the lost benefit for each virtual customer is (that is, if the user has defined shipping as an available option). The geographic distribution represents the lost benefit to each customer within the virtual available market due to the inconvenience of traveling to the point-of-sale location (that is, the venue) of the product. By right-clicking on the geographic component 147, selecting “Properties”, and clicking a Set tab, for example, a user might gain access to a dialog box allowing the user to describe the population distribution within the market. Such description might be carried out, for example, by specifying the number of avenues and streets that make up a city grid, as well as the location of the central business district (CBD) if the city's population is not evenly distributed (such a city grid could be designed to resemble the layout of Manhattan, N.Y., for example, except that each city block might be made to be mathematically perfectly square). In one embodiment, each sector is permitted up to one geographic component 147. It only makes sense for a user to locate a geographic component 147 within a sector that also has a market engine component 153. Every product within a sector that has a geographic component 147 will trigger an inconvenience cost for every customer, this inconvenience cost being less for some than for others. This inconvenience cost is subtracted from the benefit of each product and will be assessed by the profit maximization engine 170 during evaluation of the overall attractiveness of each product to each virtual customer. The term lost benefit distribution may also be used as a synonym for geographic distribution. As the geographic component 147 describes the location in the context of the distribution channel for each product in the market, the geographic component 147 has no upstream or downstream market components, and is thus shown on its own, not connected to any other market component 135, in the margin at top right in the sector diagram 115 of FIG. 3.

Company components 148 indicate price-competitive and/or non-competitive relationships among products 151 to the profit maximization engine 170. This being the case, the company component 148 will typically not contain any customer distributions 155. As an example, if a particular company has three products 151 in the market, then it would typically be the case that the company would not wish for these three products 151 to engage in price competition with one another. Instead, each product 151 would compete on its own merits against competitor products 151 supplied by other companies. Similarly, where a company sells a product 151 alongside a sales channel partner company (e.g., in a situation where you can buy an airline ticket from either an airline or a travel agent), such channels would not typically be engaged in price competition against each another. As another example, a product 151 may be owned by a group of companies, for example, in the case of a joint venture. When a single company owns more than one product 151 competing in the same market (that is, such products 151 are connected to the same market engine component 153), it is preferred that the user correctly identify such price non-competitive relationships so as to indicate to the profit maximization engine 170 that such products 151 are not in price competition. Based on affiliation(s) as indicated by any company component(s) 148, the profit maximization engine 170 in such an embodiment is able to group products in such a way as to avoid price competition between products owned by the same company or otherwise affiliated so as to not be in price competition.

That is, products owned by different companies will typically be in price competition with one another, and it is preferred that this be reflected in the price-competitive or non-competitive grouping as indicated by company component(s) 148. In contrast, products owned by the same company will probably only very rarely be in price competition with each other. In some circumstances, a given product may be owned by more than one company because they have joined forces through partnership, joint venture, or distribution agreement. In such a case, it is often true that all other products sold by each of the companies affiliated in this way would not be in price competition with the given product. That is, while such a product may be in price competition with other products in the market, it may be the case that such products are priced so as to maximize profitability of all companies with an ownership interest in such a product. Such price-competitive and non-competitive relationships may be modeled using the company component 148.

For example, the products Pepsi Cola® and Diet Pepsi® (both registered trademarks of PepsiCo, Inc., of Purchase, N.Y., USA) might be assumed not to be in price competition, in which case both products would be priced relative to other products in the market to maximize the overall profitability to the common manufacturer of both. But if Pepsi Cola® and Diet Pepsi® were to engage in price competition against each other, then, because the products are so similar, it may well be the case that Bertrand competition would cause the price of each to be driven down toward its marginal cost. Here, the company component 148 would indicate such price-competitive and non-competitive relationships to the profit maximization engine 170.

Based upon price-competitive and/or non-competitive relationships as indicated by connections the user has created between product component(s) 151 and company component(s) 148, the profit maximization engine 170 is then able to organize products 151 into price-competitive and/or non-competitive groups. When the profit maximization engine 170 attempts to find profit-maximizing prices for products 151, it is preferred that this be carried out only with respect to products 151 that are mutually price-competitive as indicated by the company component 148. In some embodiments, an alias operator 144 permits creation of a company component alias that is logically linked to its parent company component 148. Like company components 148, company component aliases may be used to identify those products that are owned by the company corresponding to the parent company component 148.

Aggregate components 149 are typically used to aggregate customer preferences for multiple features together. For example, an aggregated “Power” product benefit might be comprised of the sub-benefits “Torque”, “Energy”, and “Weight”. While it would be most typical in such cases for the benefits of the respective features to be added together (this is the basis of Conjoint analysis), the aggregate component 149 can also multiply and perform other fundamental types of operations to the upstream customer distribution data. Aggregate components 149 have the capability of separately aggregating (e.g., adding, multiplying, averaging, taking a maximum or minimum, etc.) each of the two customer distributions 155 that make up the primary distribution pair 156 (i.e., the benefit distribution 158 and the cost distribution 159) from connected upstream components. The user can specify the type of aggregation from within the Set tab and the Cost tab. In some embodiments, the aggregate component 149 may be used to aggregate together a collection of market components within the product definition pipeline in order to simplify the market map. In some embodiments, an alias operator 144 permits creation of an aggregate component alias that is logically linked to its parent aggregate component 149. Such an aggregate component 149 alias would inherit the primary distribution pair 156 from its parent aggregate component 149 but inherit none of the internal distributions 157. In such an embodiment, the aggregate component alias would not be capable of aggregating upstream customer distribution in all the ways that the parent aggregate component 149 can; instead, an aggregate component aliases would be capable of summing its primary distribution pair 156 with primary distribution pairs from upstream components. Note, with respect to use of the term “aggregate” at aggregate component 149, that although the aggregate component 149 does act to aggregate upstream customer distributions 155, aggregation does not actually occur, in at least some embodiments, until it is done by the model compiler 130 before the products 151 are handed off to the profit maximization engine 170.

Products 151 in the present embodiment comprise sets of benefits and costs. Typically, a product 151 would be the sum of source components 139 and aggregate components 149, but other market components 135 may also contribute to the overall benefit of a product 151. For example, the scale component 146 would commonly be adopted as an upstream component to a product component 151. Product components 151 typically sit at the tail end of the product definition pipeline. The benefit distribution 158 from a product component 151 is typically the sum of a number of output distributions from upstream components. The benefit distribution 158 of a product component 151 represents the total gross benefit that each virtual customer assessing the product is likely to enjoy if they choose to purchase the product 151. The cost distribution 159 of a product component 151 is similarly made up of the sum of a number of cost distributions 159 from upstream components. In one embodiment, product components 151 also have the special capability of offering diminishing marginal costs. In one embodiment, diminishing marginal costs might, for example, be set by right-clicking on the product component 151, selecting “Properties”, and clicking on a Cost tab. The user may specify that the product 151 be sold for a fixed price in the market. Alternatively, the user may specify that the price be optimized by the profit maximization engine 170 to maximize profit to the company. Price might, for example, be set by right-clicking on the product component 151, selecting “Properties”, and clicking on a Set tab. In some embodiments, an alias operator 144 permits creation of a product component alias that is logically linked to its parent product component 151. Such a product component alias would inherit the primary distribution pair 156 from its parent product component 151 but inherit none of the internal distributions 157. Product components 151 and product component aliases are each capable of being connected to market engine components 153; in at least one embodiment, these are the only types of market component 135 that can be connected to a market engine component 153. Furthermore, product components 151 and product component aliases are each capable of being connected to company components 148. Like its parent product component 151, a product component alias can set a starting price and have the profit maximization engine 170 generate a profit-maximizing price. However, in at least one embodiment it is the case that, unlike its parent product component 151, a product component alias cannot enjoy diminishing marginal costs.

The market engine component 153 acts as a gateway between the graphical user interface 110 at the software front end and the profit maximization engine 170 at the software back end. In the exemplary list of icons shown in FIG. 4, the market engine component 153 is represented by an icon in the shape of an invisible hand to symbolize Adam Smith's invisible hand of the market. Only product components 151 and product component aliases can be connected to the market engine component 153. When products 151 in a market under study are connected to the market engine component 153 in the way described, the profit maximization engine 170 can be made to run a Nash equilibrium pricing optimization algorithm to determine the profit-maximizing price for each product 151 in the market. The profit maximization engine 170 determines the profit and market share of each product 151 at the end of the product definition pipeline that is connected to the market engine component 153. Note that multiple market engine components 153 can exist within a market model, but that a sector diagram 115 need not necessarily have a market engine component 153. It would be typical for a user to create multiple sectors without a market engine component 153 in order to define the benefits and costs along the product definition pipeline.

Referring to FIG. 7, this shows an example of a profit maximization engine 170 and functional blocks associated therewith, the profit maximization engine 170 being one of the functionalities shown in the software functional block diagram of FIG. 2. The profit maximization engine 170 of the present invention makes use of the concept of Nash equilibrium. In game theory, a Nash equilibrium is a steady-state solution in which no player has anything to gain by changing strategy. In microeconomics, a Nash equilibrium is reached when all companies are maximizing their profits given the prices that all other companies are charging for their products. That is, a Nash equilibrium is reached when, for all companies participating in a market, any further increase or decrease in price by a company would cause that company's profits to decrease.

When products 151 in a market under study are connected to the market engine component 153 in the way described, the profit maximization engine 170 can be made to run a Nash equilibrium pricing optimization algorithm to determine the profit-maximizing price for each such product 151. In one embodiment, the profit maximization engine 170 attempts to locate a Nash equilibrium point for each product 151 in the market through use of an iterative algorithm referred to herein as a pricing funnel 172. As explained above with reference to FIG. 4, in one embodiment, the company component 148 can be used to specify price-competitive or—non-competitive groups for purposes of defining which products 151 are mutually price-competitive and which products 151 are not mutually price-competitive.

By combining the value of all of the constituent features for all the products 151 in the market, a simulator can dynamically modify the price for each of those products 151 and make an assessment of which customers would buy what. Profitability for each product 151 is thereby determined at each of the different price points. A Nash equilibrium is reached when the profit from all products is maximized; i.e., no product in the market would benefit from either raising or lowering price. The price elasticity of demand for each product when this equilibrium is reached (delta-price I delta-quantity)=1.00.

At FIG. 7, products 151 are shown as one functional block that is input to the profit maximization engine 170. As mentioned above, in one embodiment, rules governing sector diagrams 115 permit only product components 151 and aliases of product components 151 to be connected to the market engine component 153. This is so because the profit maximization engine 170 in such embodiments is preferably designed to operate on products 151. As such, whereas the individual customer distributions 155 associated with market components 135 other than the market engine component 153 are labeled in FIG. 5 as being “uncompiled,” the customer distributions 155 at the products 151 shown as input to the profit maximization engine 170 in FIG. 7 are labeled as being “compiled,” this compiling or aggregating of the individual customer distributions 155 associated with respective market components 135 other than the market engine component icon 153 being performed by the model compiler 130 as shown in FIG. 2 as part of the handoff by the market engine component 153 of products 151 to the profit maximization engine 170. In compiling or aggregating the uncompiled customer distributions 155 that are associated with respective market components 135 other than the product component 151 to produce compiled customer distributions 155 that are associated with product components 151 for hand off to the profit maximization engine 170, the model compiler 130 aggregates or compiles those individual uncompiled customer distributions 155, which typically involves adding them up, but may in some cases also involve multiplying, filtering, counting, and/or applying any of various other operations.

Note that the market engine component icon 153 may appear in the sector diagram 115, and so the market engine component 153 forms part of the market model data structure 120 for purposes of rendering the market engine component icon 153 at the graphical user interface 110. However, because the market engine component 153 does not have customer distributions 155 associated with it but instead acts as trigger to handoff the customer distributions 155 associated with the product components 151 to the profit maximization engine 170 (the compiled customer distributions 155 associated with product components 151 being produced by the model compiler 130 from the uncompiled customer distributions 155 associated with various individual market components 135 other than the product component 151), the market engine component 153 is not included among the market components 135 shown in the exemplary market model data structure 120 at FIG. 5.

In one embodiment, price is taken to be the individual price paid by an individual virtual customer for a product 151. For ease of description, it will be assumed for purposes of describing the present embodiment that individual negotiation is not possible, so that the price paid in the event of a purchase of a particular product 151 would be the same for any virtual customer. Of course, there is no particular objection to employment of profit maximization algorithms that simulate (e.g., by introducing a random component to the price paid) individual negotiation such that price paid in the event of a purchase might vary from virtual customer to virtual customer. The sum of the price paid by all virtual customers represents the revenue a company would receive for selling the product 151.

At FIG. 7, pricing funnel 172 refers to an algorithm used by the profit maximization engine 170 in one embodiment to determine the profit maximization price for each product 151 that is connected to the market engine component 153. Any parameter(s) 125 necessary for operation of the pricing funnel 172 may be set by the user at the market engine component 153. The profit maximization engine 170 calculates a profit-maximizing price for each product 151 connected to the market engine component 153. Within each internal iteration of the algorithm used by the profit maximization engine 170, the profit maximization engine 170 selects each product 151 in turn, allocating each to be a target product in sequence. For each target product that is so allocated, the profit maximization engine 170 will examine all products 151 that are in price competition with the target product as indicated by the company component 148 and will calculate the impact of changing the target product's test price in accordance with relative progress along the internal time line of the pricing funnel algorithm. Once a new test price has been calculated, the profit engine will allocate the next product 151 in the sequence to be the target product. At each internal iteration that is carried out by the profit maximization engine 170, the test price of the test product is increased by a large margin (the new price being referred to herein as an up-up price), by a smaller margin (the new price being referred to herein as an up price), is unchanged, is decreased by a small margin (the new price being referred to herein as a down price), and is decreased by a larger margin (the new price being referred to herein as a down-down price). The range of test price changes will narrow as one proceeds along the internal timeline. That is, the up-up price percentage change, the up price percentage change, the down price percentage change, and the down-down price percentage change will all decrease as iterations of the profit maximization engine 170 proceed. In this way, the pricing funnel 172 allows the user to specify increasingly narrow price changes that are allowed for each product test price. In those circumstances in which no virtual customers choose to purchase the tested product 151, price might be decreased by a margin sufficient to arrive at what is called a no-sale price, where the margin used to arrive at the no-sale price is, for example, at least as large as the margin used to arrive at the down-down price. When the profit maximization engine 170 reaches the last internal iteration, then a comparison will be made to determine whether a Nash equilibrium has been reached and profit-maximizing prices have been found for the respective products 151. In the event that despite reaching the end of the pricing funnel 172 it is the case that one or more of the products 151 might still improve profitability by either raising or lowering price, an error or warning alert will be issued. Note that when a profit-maximizing equilibrium point is found by the profit maximization engine 170, price at the profit-maximizing equilibrium point may be considered to be an optimal price, since it is the price that will in theory result in maximum profit. Since as part of the process of finding a Nash equilibrium point the profit maximization engine 170 calculates which virtual customers purchased which products, and at what price each such purchase was made, alternatively or in addition to determination of profit-maximizing price for each product in the market, the profit maximization engine 170 is able, in some embodiments, to output results in the form of market share by quantity for each product in the market, market share by revenue for each product in the market, market share by profitability for each product in the market, marginal cost for each product in the market, customer ratings (objective or subjective) of each product feature, product similarity, or in the form of any of various other market metrics. Such market metrics may be used in forward looking fashion to understand the market consequences of customer distributions modeled at the sector diagram 115, or such market metrics may be used in backward-looking fashion to assess how closely the market modeled at the sector diagram 115 agrees with a market under study. Ability to flexibly go back and forth between customer distributions on the one hand and equilibrium price or other such market metric on the other allows the user, in some embodiments, to iteratively tune the market model to agree with observed market characteristics (backward looking) or explore market behavior under changing market scenarios (forward-looking).

Referring to FIG. 8, this is a working example of a sector diagram 115 for a simplified model of an airline market for passengers flying from a common origination location “A” to a common destination location “X”, so the market is referred to as the “Destination X Airline Market”. Here, it is assumed that air transportation is the only means of travel for all potential customers, but that a customer can choose not to travel at all (a potential customer might choose to just stay home). In the present working example, there are only three airlines flying from Location A to Destination X, and each airline respectively offers only one class of travel: the first airline is a discount/economy airline (only offers economy seats), the second airline is a business-class airline (only offers business-class seats), and the third airline is a first-class airline (only offers first-class seats). The flights offered by these three airlines are respectively modeled as three product component icons 151 appearing toward the right side of the sector diagram 115 in FIG. 8. Each airline offers flights departing at exactly the same time and arriving at exactly the same time. Each airline uses the same type of aircraft, and no airline is known for better or worse reliability than any other. Furthermore, each airline has an unlimited number of seats. In the present working example it will be assumed that the only thing that differentiates one airline from the other is the class of travel.

The value of a first benefit, referred to for purposes of the present working example as the “transportation benefit,” will vary among potential passengers. That is, some passengers place a very high value on travel, while other passengers place a low value on travel. Such a range of values may be modeled by the software 100 as a benefit distribution 158 having a histogram in the shape, for example, of a normal (Gaussian) distribution, the parameters 125 for which could be set by right-clicking on the corresponding component icon 139 (the icon appearing at top left in FIG. 8), selecting “Properties”, and clicking on a Set tab.

Likewise, the value of a second benefit, referred to for purposes of the present working example as the comfort benefit, will vary among potential passengers, some passengers placing a very high value on comfort, and other passengers not placing a particularly high premium on comfort. Again, such a range of values may be modeled by the software 100 as a benefit distribution 158 in the shape of a normal distribution in the same manner as above.

However, because passengers don't fly on an airline just to sit in a comfortable seat, the comfort benefit is universally (i.e., for all passengers) set to be lower in value than the transportation benefit. This universality means that the transportation benefit can be said to be vertically differentiated from the comfort benefit.

An important question for each of these airlines is “What is the profit-maximizing price I can charge for my seats given that all other airlines will also seek to charge the profit maximizing price for their seats?”. The market simulator/optimizer in accordance with one embodiment of the present invention can answer this question, as well as many other questions that the airlines might have about their industry.

Based on what is known to this point, it is possible to deduce how passengers would distinguish their choice of flying on the economy-class airline versus the business-class airline. That is, both of these two options offer the transportation benefit, which has been modeled as an undifferentiated feature, and so is assumed in the present working example to be ignored by passengers when making a selection. However, note that the business-class airline offers the vertically differentiating comfort benefit, which presumably comes at an additional cost to the airline. Consequently, the market simulator/optimizer would determine that the business-class airline should charge more for seats and that these airlines will split the passengers (although probably not evenly).

The next question to consider is how passengers would choose between the business class airline and the first-class airline. Because it is here assumed that passengers who value the comfort benefit would also be likely to value a third benefit, referred to for purposes of the present working example as the “luxury benefit,” this luxury benefit is modeled at the sector diagram 115 in FIG. 8 through use of a scale component icon 146 (bottom left in drawing); that is, the parameters 125 at this scale component 146 would be set so as to have the effect of enhancing or amplifying the comfort benefit for certain passengers. That is, although it may be assumed that there will be a high degree of correlation between the comfort benefit and the luxury benefit, it will in general be true that the amount of extra benefit may vary widely from passenger to passenger. For example, it may even be the case that some passengers will actually prefer the business-class airline because additional luxury would, for them, detract from their business requirements. Such variation among passengers in how they respectively perceive the benefits from the comfort benefit and the luxury benefit is a good example of horizontal differentiation. Here, because of the correlation, the first-class airline offers both horizontal differentiation and vertical differentiation with respect to the business-class airline. Based on the market modeled at the sector diagram 115 in FIG. 8, the profit maximization engine 170 is able to determine the profit-maximizing price for each airline based upon the mean and standard deviation of each of the benefits defining the market, as well as the marginal costs to the airlines for providing these benefits. It will also be possible to determine the market share for each airline, including the number of passengers who choose not to fly.

While the market simulator/optimizer of the present invention can make direct use of benefit (partworth) distributions obtained from traditional Conjoint studies (e.g., using the external component 137), it need not do so. Alternatively or in addition to traditional Conjoint partworth data, the market simulator/optimizer in accordance with some embodiments of the present invention may internally generate its own virtual partworth distributions having, for example, a normal (also referred to as a Gaussian or bell-curve) shape. Moreover, in some embodiments, partworth data obtained from traditional Conjoint analysis can be flexibly mixed and matched with synthetic or internally generated virtual partworth data generated by the software 100. Relying on this fact, the profit maximization engine 170 may, in some embodiments, be employed in either or both of two ways: (1) backward-looking to derive customer distributions reflecting observed market characteristics; (2) forward-looking to predict market behavior based on a given set of customer distributions. Such flexibility and the ability to mix-and-match partworth data from varied sources makes it possible for the market simulator/optimizer of the present invention to greatly extend the capabilities of traditional Conjoint analysis.

In one embodiment of the market simulator/optimizer of the present invention, a benefit distribution 158 might be obtained in any of a number of ways.

As one example, a benefit distribution 158 in the form of a sequence of partworth values for real-world customers derived from a Conjoint analysis may be imported into the software 100 through use of an external component 137.

As another example, a benefit distribution 158 for a sequence of virtual customers may be generated internally by the software 100 through use of a source component 139. A user would typically enter parameters 125 at the source component 139 to cause the benefit distribution 158 (or a histogram thereof) to have the shape of a normal (Gaussian) distribution or other such common distribution shape. The mean and standard deviation of the normal distribution, and optionally its correlation with one or more other benefit distributions 158, may be derived through curve-mapping techniques (using isocontour curves as described below) or through a tuning process conducted by the profit maximization engine 170 against a set of known data points (e.g., the known market shares of products 151 in a related market).

As yet another example, a benefit distribution 158 may be generated internally as the accumulation or transformation of one or more other customer distributions 158 in the market. For example, a demographic component 141 might be used in combination with a filter component 145 to produce a benefit distribution 158 to reflect a demographic distribution inferable from a known relationship pertaining to a given market segment. This relationship may have been identified through factor analysis or other such marketing research technique.

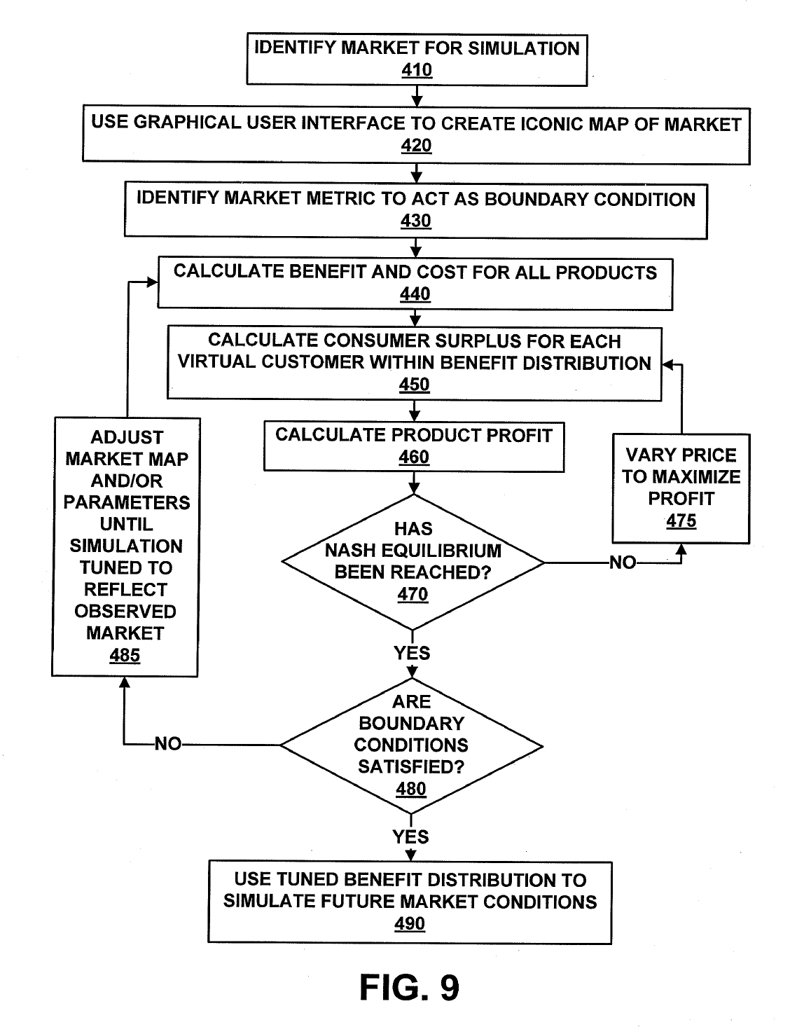

Referring to FIG. 9, this is a flowchart to assist in describing a first method for tuning a market simulator/optimizer in accordance with one embodiment of the present invention to obtain customer distributions 155 reflecting observed market characteristics. Such tuning may, for example, include adjustment to reflect vertical and horizontal differentiation as observed in a market. As an example, the market described with reference to FIG. 8 might serve as a market to be modeled using the general method in the flowchart of FIG. 9.

At FIG. 9, a market to be simulated is identified (block 410). A user then uses the graphical user interface 110 to arrange market component icons 135 in a sector diagram 115 to reflect observed market relationships (block 420). For example, market component icons 135 might be arranged as shown in FIG. 8 to symbolically represent the airline market described with reference to FIG. 8.

Continuing description of FIG. 9, the user identifies any of various market metrics to be used as boundary conditions for assessing when the market model is an accurate reflection of the market under study (block 430). For example, as such a metric, an observed split in market share between products 151 competing in a market might be used. Other suitable market metrics include the following: market share by quantity for each product in the market; market share by revenue for each product in the market; market share by profitability for each product in the market; marginal cost for each product in the market; price for each product in the market; customer ratings (objective or subjective) of each product feature; product similarity (e.g., ale versus lager, Pinot Noir versus Chardonnay, etc.). For example, such a market metric might take the form of one or more of the following observations: “Airline A has the best on-time performance, followed by Airline B, and then by Airline C”; “Airline B has the best customer satisfaction rating, followed by Airline C, followed by Airline A”; “Airline C has the most legroom, followed by Airline A, followed by Airline B”, and so forth.

A virtual available market is simulated, with benefit distribution(s) 158 and cost distribution(s) 159 being generated for the virtual customers in the virtual available market (block 440). The profit maximization engine 170 uses the pricing funnel 172 to find the profit-maximizing equilibrium point (blocks 450 through 475). Specifically, for each virtual customer within the benefit distribution 159, the pricing funnel 172 starts with an initial estimate of product price, iteratively calculates consumer surplus (block 450) and product profit (block 460), and following each iteration makes a determination as to whether Nash equilibrium has been reached (block 470). In the event that it is determined that Nash equilibrium has not been reached (NO at block 470), product price is varied (block 475) and another iteration of the pricing funnel 172 is carried out (block 450). In the event that it is determined that Nash equilibrium has been reached (YES at block 470), processing proceeds to block 480.

At block 480, the user evaluates the boundary conditions for the market metric identified at block 430. For example, a user might evaluate whether a market share split as determined by the profit maximization engine 170 agrees with observed market share split between products 151 in the market under study (block 480). If boundary condition(s) are not satisfied (NO at block 480), the user would adjust the market map (arrangement of market component icons 135 in the sector diagram 115, etc.) and/or parameters 125 entered at the sector diagram 115 (block 485) until the desired boundary conditions have been met (YES at block 480). In some embodiments, such adjustment of the market model—more specifically, adjustment of at least parameters 125, and to the extent feasible, adjustment also of the market map itself—may be carried out automatically. Such automatic adjustment of the market model to tune benefit distribution(s) 158 may be carried out in more or less random fashion until the boundary conditions in question are satisfied, or in some embodiments, such automatic adjustment might be carried out intelligently through use of algorithms designed to estimate what change(s) in the market model will be likely to cause the market model to satisfy, or more closely approach satisfaction of, the boundary condition in question.

Once the market model has been tuned to reflect observed market conditions, the user can make use of the market model in any of a number of ways, including outputting the benefit distribution 158 so obtained as partworth data (which would frequently be easier and less costly than commissioning a Conjoint study) or using the market model to predict future market behavior (block 490).

The market simulator/optimizer of the present invention is capable of balancing the average or monolithic preferences all customers have for products in a market versus any heterogeneity that might exist in the preferences of those customers. If the customers in a market, on average, favor Product 1 over Product 2 (at identical prices), then Product 1 would typically have a greater market share than Product 2. But the amount of market share that Product 2 enjoys will in general depend upon how heterogeneous the customers in the market are assumed to be. Product 2 may still enjoy considerable market share if customers are assumed to be sufficiently heterogeneous and if Product 2 offers sufficiently different features as will suit a subset of those heterogeneous customers. In microeconomic terms, the average value of a product to a customer distribution is a measure of its vertical differentiation. The degree of heterogeneity is a measure of its horizontal differentiation. In statistical terms, vertical differentiation is measured by taking the mean of the dollarmetric utility of the customer distribution for each product. Horizontal differentiation is measured by correlation between or among customer distributions for respective products. One embodiment of the market simulator/optimizer of the present invention is capable of modeling vertical and horizontal differentiation by taking advantage of the statistical relationship between vertical differentiation and horizontal differentiation. This statistical relationship was discovered by the inventor and can be expressed by a set of mathematical curves called isocontour curves.

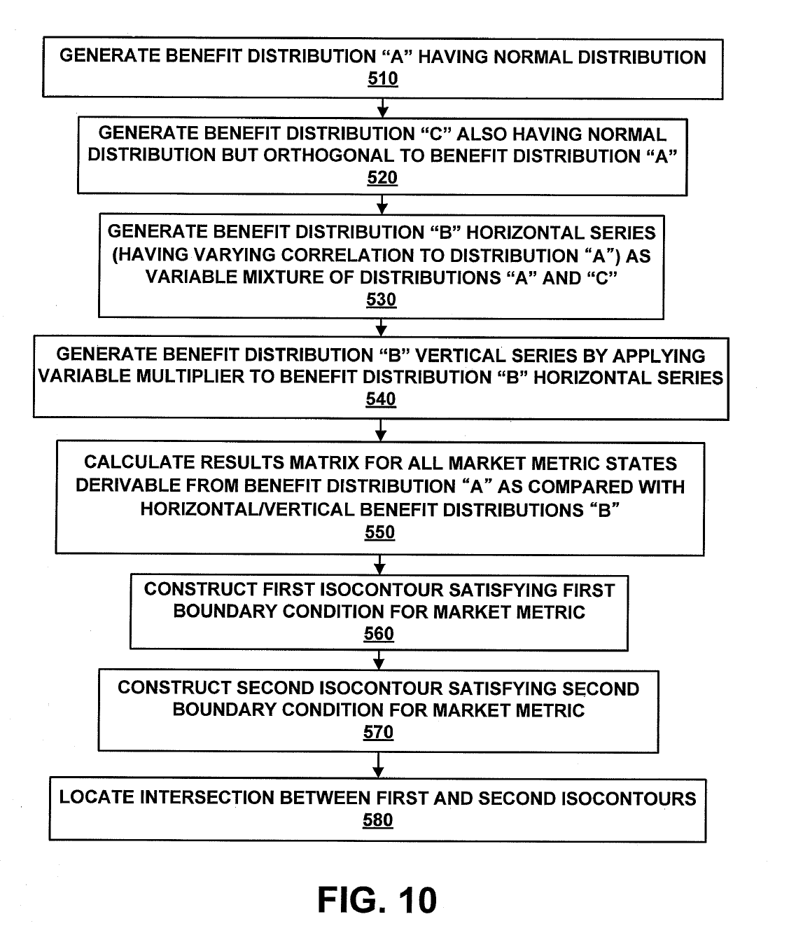

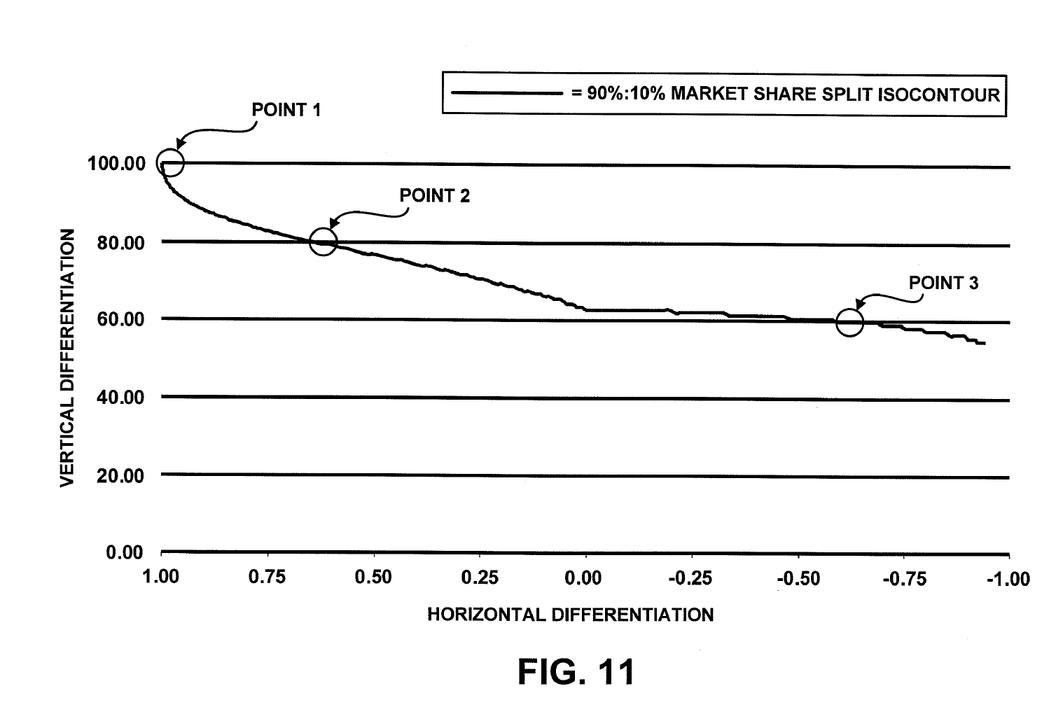

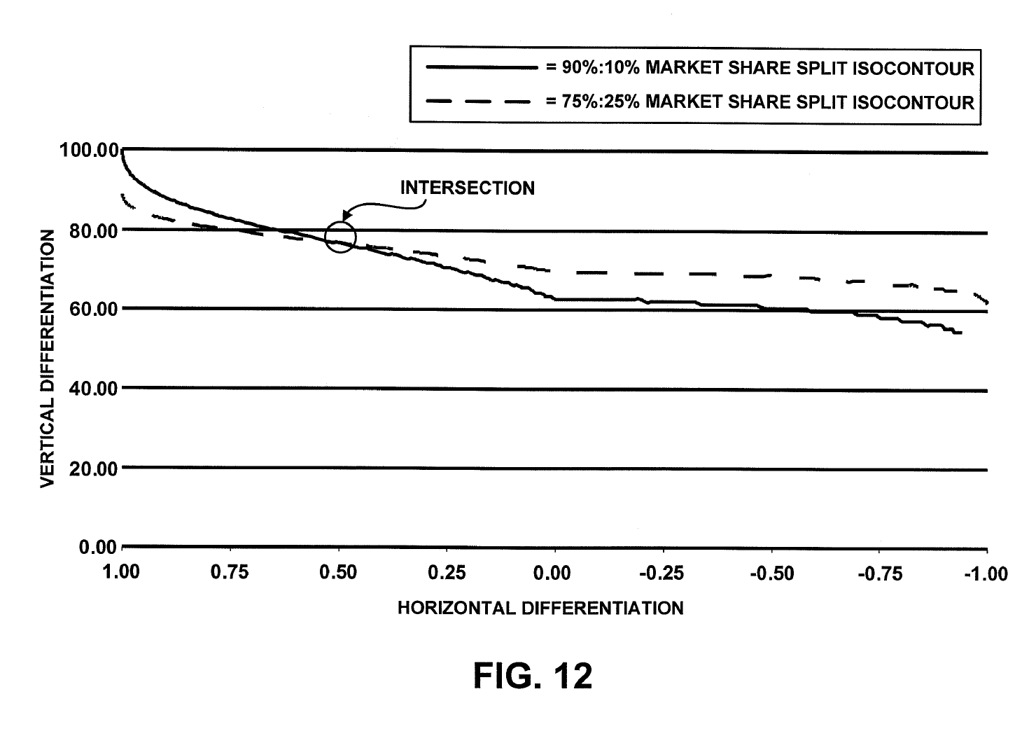

FIG. 10 is a flowchart to assist in describing a method for using market share split isocontour curves to tune a market model such as that indicated by the sector diagram of FIG. 8 to reflect vertical and horizontal differentiation observed in a market. FIG. 11 shows a first market share split isocontour curve plotted on a chart showing the relationship between vertical and horizontal differentiation in accordance with the procedure of the flowchart of FIG. 10. FIG. 12 is a chart showing a second market share split isocontour curve that has been added to the chart of

FIG. 11. As one concrete example of how the procedure described below might be used in practice to tune a market model to reflect observed vertical and horizontal differentiation in a market, the reader might briefly refer to FIG. 8 and imagine a situation in which the scale component 146 is being used to model a luxury benefit that is being defined based on its correlation to a comfort benefit. In such case, observed or postulated market share split between competitors might be chosen as one exemplary market metric for evaluating the accuracy of the market model, the market model being determined to be accurate when boundary conditions for such market metric are met. Such boundary conditions might, for example, be the market share split between competitors under, say, two different scenarios that serve as basis for finding an intersection between isocontours as described in more detail below.

With simultaneous reference to FIGS. 10 through 12, a method for using isocontour curves to obtain customer distributions 155 reflecting vertical and horizontal differentiation observed in a market will be described.

At FIG. 10, a source component 139 is used to generate a first benefit distribution 158, referred to as benefit distribution “A”, having a normal (Gaussian) distribution (block 510).

Note, in the present embodiment, that when a correlation component 143 is used to generate a family of benefit distributions 158, the user is able to specify the degree of correlation between or among benefit distributions 158, in which case the benefit distributions 158 so generated will have known correlation with respect to each other. However, when the source component 139 is used in succession to generate a plurality of benefit distributions 158, while the user will in general be able to specify values for the mean and standard deviation of each benefit distribution 158 so generated, as an internal distribution 157 referred to as a random distribution and containing randomized values is used by the source component 139 to generate a benefit distribution 158, the benefit distributions 158 produced by successive uses of the source component 139 (e.g., through placement of multiple source component icons 139 on the sector diagram 115) will in general be uncorrelated to each other and so are said to be mutually orthogonal.

At block 520 in the flowchart of FIG. 10, if a source component 139 is used to generate a second benefit distribution 158, referred to as benefit distribution “C”, also having a normal (Gaussian) distribution, and having the same mean and standard deviation as benefit distribution “A”, this benefit distribution “C” will be orthogonal, or uncorrelated, to benefit distribution “A”.

Benefit distribution “A” and benefit distribution “C” are then mixed in varying degrees to generate a series of benefit distributions, referred to as a benefit distribution “B” horizontal series (block 530). For example, the benefit values of benefit distribution “A” might be scaled by a multiplier such as 90%, and the benefit values of benefit distribution “C” might be scaled by a multiplier such as 10%, and the two added together to form a mixed distribution as part of the benefit distribution “B” horizontal series. Introduction of varying amounts of the uncorrelated or orthogonal benefit distribution “C” therefore causes the benefit distribution “B” horizontal series to have varying degrees of correlation to benefit distribution “A”. Taking benefit distribution “A” as reference or baseline, a family of curves forming the benefit distribution “B” horizontal series can be generated that range in correlation (with respect to benefit distribution “A”) from 1.00 to −1.00 (a negative number here implies inverse correlation).

Once the benefit distribution “B” horizontal series has been obtained in accordance with block 530, a variable multiplier, ranging in value from 1.00 to 0.00, may be applied to the benefit distribution “B” horizontal series to obtain a benefit distribution “B” vertical series (block 540).

A results matrix is calculated by comparing the benefit values within benefit distribution “A” to the benefit values within benefit distribution “B” for each point in the benefit distribution “B” horizontal series and benefit distribution “B” vertical series, and counting the number of occasions when, for each virtual customer, the benefit value at benefit distribution “A” is greater than the benefit value at benefit distribution “B” (block 550). When calculated in this way, the results matrix will contain the market share of “A”.

Isocontours for any market share split can now be plotted. That is, for a given pair of benefit distributions “A” and “B”, the results matrix contains the information relating vertical and horizontal differentiation to market share. Moreover, for any given market share split, there is not just a single vertical or horizontal differentiation value that will deliver the market share split in question but a whole family of vertical/horizontal differentiation value pairs. These paired combinations of vertical and horizontal differentiation values that will produce a given market share split are the coordinates of the points that are plotted to obtain the curves referred to herein as “isocontours.” For example, FIG. 11 shows the results of plotting the vertical and horizontal differentiation combinations that will produce a 90%: 10% market share split for a given pair of benefit distributions, where a first benefit distribution “A” acts as baseline or reference and the degree to which a second benefit distribution “B” is correlated to the first benefit distribution is varied from perfect correlation (1.00), through no correlation (0.00), to perfect inverse correlation (−1.00).

With continued reference to FIG. 10, a first isocontour satisfying a first boundary condition for the market metric is constructed (block 560). For example, in the example described below with reference to FIG. 11, a first isocontour showing the vertical and horizontal differentiation combinations that will produce a 90%:10% market share split is plotted in solid line. Furthermore, a second isocontour satisfying a second boundary condition for the market metric is constructed (block 570). For example, in the example described below with reference to FIG. 12, a second isocontour showing the vertical and horizontal differentiation combinations that will produce a 75%:25% market share split is plotted in dashed line over the 90%:10% that was plotted in solid line at FIG. 11. Since it is assumed, in the present embodiment, that the market model must satisfy both boundary conditions, the vertical and horizontal differentiation at the intersection of the two isocontours can be used as parameters 125 to be entered at the market component 135 in question. For example, such vertical and horizontal differentiation values from the intersection of isocontours corresponding to boundary conditions may be entered as parameters 125 for the scale component 146 used to generate a luxury benefit having an observed degree of correlation to the comfort benefit as described in the example given with reference to FIG. 8 (block 580).

Of course, as the accuracy of the market model will in general depend not only on the vertical and horizontal differentiation set as parameters 125 for any one market component 135 but on the overall arrangement of market components 135 that make up the market map as well as vertical and horizontal differentiation (correlation) between all relevant pairs of market components 135 in that market map, the steps in the flowchart of FIG. 10 would preferably be carried out for all market component pairs displaying some degree of correlation.

Construction of isocontours and will be described in more detail with reference to the example given in FIGS. 11 and 12, below.

As seen in the example presented with reference to FIGS. 10 through 12, in accordance with the principles of one embodiment of the invention, it can take surprising little input data to accurately model observed vertical and horizontal differentiation in a market. This is because only one data point is sufficient in theory for generation of each market driver or product benefit (of course, more data is usually better). Where a benefit distribution 158 if of known distribution shape, e.g., the benefit distribution is a normal (Gaussian) distribution, it is in general possible to describe that benefit distribution 158 in terms of the mean value of the benefit in question and the distinctiveness of the benefit in question, this latter factor being expressible as the correlation of the benefit in question to another benefit. These two factors can be represented on a two dimensional chart such as are shown at FIGS. 11 and 12.

At the charts shown in FIGS. 11 and 12, the vertical and horizontal axes are respectively labeled “vertical differentiation” and “horizontal differentiation.” In the context of the present embodiment, vertical differentiation in the marketplace is here modeled mathematically as the mean of a second benefit distribution as compared with the mean of a first benefit distribution that serves as baseline. What is meant here by the mean of a benefit distribution for a particular product feature is the average of the respective benefit values (partworth values) that product feature has for the respective customers making up that benefit distribution as compared with the corresponding mean for the baseline distribution; e.g., the mean of a benefit distribution for a multiplicity of virtual customers can be found by adding up the benefits (partworth values) perceived by all of the virtual customers and dividing this sum by the number of virtual customers. Furthermore, in the context of the present embodiment, horizontal differentiation in the marketplace is here modeled mathematically as the degree to which the second benefit distribution is correlated to the first benefit distribution that serves as baseline. What is meant here by the correlation of a second benefit distribution (for a second product feature) to a first benefit distribution (for a first product feature) is the degree to which the same customer perceives the same benefit (partworth value) in the second product feature as that customer perceived in the first product feature; e.g., a sense of the degree to which two benefit distributions (sharing the same common virtual customers) are mutually correlated might be obtained by plotting benefit (partworth value) versus virtual customer (e.g., the offset, ordinal, or index of the virtual customer in the customer distribution array) for the two benefit distributions, and noting the degree to which the shapes of the two benefit versus customer profiles so plotted are mutually similar.

That is, at FIGS. 11 and 12, a series of benefit distributions B are compared to a benefit distribution A, these benefit distributions A and B splitting market share in the ratio 90%:10% at all points on the isocontour plotted in solid line at FIGS. 11 and 12. Every such benefit distribution in the B series has a mean value and a correlation with respect to A as determined by the procedure described above used to create the results matrix. The mean value of B expressed as a fraction of A is plotted along the vertical axis, the vertical axis here being normalized such that the baseline value provided by A is 100.00; i.e., B provides the same mean benefit as A when B has a vertical axis coordinate of 100.00. Note that in the discussion that follows, the units of the vertical axis will for convenience be taken to be dollars, but any appropriate measure of value, including fictitious units such as “utils,” might just as easily have been used.

Correlation of benefit distribution B with respect to benefit distribution A is plotted along the horizontal axis, 1.00 representing perfect correlation, 0.00 representing no correlation, and −1.00 representing perfect inverse correlation.

Note that instead of “vertical differentiation” and “horizontal differentiation,” a marketing researcher might use the terms “point of parity” and “point of difference.” Points of parity are typically core benefits that are undifferentiated, and so sit side-by-side on the vertical axis of a chart such as that shown in the drawings, but the terms may be misleading if a core benefit is also differentiating. Furthermore, a decision maker might think of the vertical axis in the charts at FIGS. 11 and 12 as representing “objective criteria,” and the horizontal axis as representing “subjective criteria.” From the standpoint of the layperson, those features that sit on the vertical axis might be thought of as things that make products “better,” while those features that sit on the horizontal axis might be thought of as things that products “different.”

By way of example, take the case where are two products, A and B, each of which has a single benefit. Here, product A is taken as a baseline or reference having a known benefit distribution, and the goal here is to find a benefit distribution for product B that will reflect the appropriate degrees of vertical and horizontal differentiation to agree with what is observed in the market.

Referring to FIG. 11, this shows a 90%:10% market share split isocontour curve plotted on a chart showing the relationship between vertical and horizontal differentiation. For purposes of the present description, it is assumed at FIG. 11 that products A and B are observed to split market share such that, for example, A has a 90% market share, and B has a 10% market share. If the isocontour represented by the solid curve shown in FIGS. 11 and 12 plots vertical and horizontal differentiation for all 90%:10% market share splits in the market under study, then it must be the case that the desired benefit distribution for B that will accurately reflect vertical and horizontal differentiation observed in the market resides somewhere on the solid curve shown in FIGS. 11 and 12.

Taking one extreme case, it may be that B is a commodity, in which case B might offer almost as high a benefit as A but not be very distinguished from A. If this were the case, B's benefit distribution would reside on the solid curve in FIGS. 11 and 12 at a point toward the left in the drawing. For example, at FIG. 11, the point marked “POINT 1” represents the extreme case in which B provides the same mean benefit as A (here taken to be $100) and is perfectly correlated with A (correlation=1.00). Or taking a more moderate case, the point marked “POINT 2” at FIG. 11 represents a case in which B provides a mean value of $80, meaning that B is vertically differentiated from A by −$20, and has moderate horizontal differentiation relative to A as indicated by a correlation of 0.66 with respect thereto.

At the other extreme, it may be that B is highly differentiated relative to A, in which case B might offer a much lower benefit than A but be highly distinguished relative to A. This might be the case, for example, if B is a product having good brand-name recognition. Where B is highly differentiated relative to A, B's benefit distribution will reside on the solid curve in FIGS. 11 and 12 at a point toward the right in the drawing. For example, at FIG. 11, the point marked “POINT 3” represents a case in which B provides a mean value of $60, meaning that B is vertically differentiated from A by −$40, and has substantial horizontal differentiation relative to A as indicated by a correlation of −0.59 with respect thereto.

Referring to FIG. 12, this shows a 75%:25% market share split isocontour curve (dashed line) that has been superposed over the 90%:10% market share split isocontour curve (solid line) of FIG. 11. This has been done because in order to learn where B's benefit distribution resides on the solid curve, a second data point is required. That is, if it is also known, for example, that A's market share would fall to 75% if A were to raise its price by some fixed amount, as represented at FIG. 12 by the 75%:25% market share split isocontour shown in dashed line in the drawing, then B must also reside on the dashed curve. Note that where the dashed curve is lower than the solid curve in FIG. 12, this is so because A takes away value from the consumer in correspondence to the increase in price. The intersection between the dashed curve and the solid curve at FIG. 12, marked “INTERSECTION” at FIG. 12, will therefore indicate where B's benefit distribution must be located.

Summarizing, since A was taken as reference or baseline, A's benefit distribution (which in the present example is assumed to be a normal distribution) corresponds, by definition, to the circled point at top left in the chart of FIG. 11. B's benefit distribution (which in the present example is also assumed to be a normal distribution) corresponds to the circled point in the chart of FIG. 12, this benefit distribution having a lower mean benefit than A, and some, but not much, correlation relative to A.

In the example given above, a partworth distribution was tuned to reflect vertical and horizontal differentiation in a market based on two isocontour curves respectively representing two market share splits, these being in the present example a 90%:10% market share split and a 75%:25% market share split. It goes without saying that isocontour curves representing any two suitable market share splits could have been used in similar fashion to achieve a similar result. Moreover, there is no objection to using more than two isocontour curves, it generally being the case that more data will permit better tuning of partworth distributions to reflect observed vertical and horizontal differentiation.

Although market share split was used as market metric in the above example, the present invention is not limited thereto, it being possible to employ any suitable market metric to assess accuracy of and/or tune the market model. That is, isocontour curves for tuning of partworth distributions to reflect vertical and horizontal differentiation need not be limited to isocontour curves representing market share split, it being possible to construct isocontour curves representing profit margin (or any other suitable measure) and to use the isocontour curves so constructed in similar fashion as described above to tune partworth distributions to reflect vertical and horizontal differentiation. This is so because there is only a limited range of mean/correlation values (represented by an isocontour) that would explain, for example, a 65% profit margin which might be observed for a particular product, and this fact can be exploited to tune the market model in the same way that market share was exploited to tune the market model above. That is, whereas in the above example two known market share splits (90%:10% and 75%:25%) were used to tune the market model, it is similarly possible to use two known profit margins, or to use one known market share split and one known profit margin, for example, to tune the market model. Furthermore, although isocontour curves representing market share split and isocontour curves representing profit margin have been given as two examples of types of isocontour curves that can be used to tune partworth distributions to reflect vertical and horizontal differentiation, there are in general any number of types of suitable isocontour curves that can be used in this fashion. For example, any of the exemplary market metrics mentioned with reference to FIG. 9 may be used.

Furthermore, although reference has occasionally been made to an “observed” market share split or other such market metric, as the simulator in accordance with some embodiments of the present invention may be used equally well whether modeling an actual or an imaginary market, except where otherwise clear from context the term “observed” should be understood in a loose sense to include market behavior as would be theoretically observable in even an imaginary or postulated market.

Although the curves shown in FIGS. 11 and 12 are here described as having been generated from a results matrix created using the procedure at blocks 510 through 560 in the flowchart of FIG. 10, equivalent information indicative of ranges of vertical and horizontal differentiation values satisfying two or more boundary conditions serving as market metric may be obtained by other methods, e.g., based on partworth data from a Conjoint survey. Furthermore, although the isocontour curves shown in FIGS. 11 and 12 were described as having been derived from two product benefit distributions respectively assumed to have normal (Gaussian) distribution shape, with market share or other such metric being determined through iterative use of a profit maximization engine, the same method can be applied, with appropriate modification where necessary, to any benefit distribution shape(s) admitting of characterization in terms of mean and correlation values. For example, there is no particular objection to using benefit distributions shapes that are uniform, Bernoulli, binomial, Poisson, patterned, and/or sinusoidal. And once the general shape of isocontour curves relating various values of a particular market metric to benefit distributions of a particular distribution shape has been determined (e.g., as a result of using a profit maximization engine to construct a results matrix as described above), it is believed that the relationship between mean and correlation on the one hand and market share or other such market metric on the other is consistent enough to allow those isocontour curves to be used to assess vertical and horizontal differentiation for any suitable product feature modeled as having a benefit distribution of the same shape, without necessarily having to use a profit maximization engine all over again to painstakingly recreate the results matrix. Furthermore, the invention is not limited to graphical methods such as that described with reference to FIG. 12 in which an intersection between isocontours is used as basis for finding specific vertical and horizontal differentiation values that will satisfy all boundary conditions of interest, it being possible to employ any suitable method for finding such specific vertical and horizontal differentiation values.

Although the present invention has been described in terms of an example in which there were 1,000 virtual customers, this number was chosen merely as one representative example, it being possible in general to employ any suitable number of virtual customers.

Although it may have been assumed for convenience of describing various aspects of the present invention that one or more of the benefit distributions and/or cost distributions in the examples presented above were of normal (Gaussian) shape, the present invention is not limited thereto, it being in general possible for the present invention to employ benefit distributions and/or cost distributions of other shapes, including, without limitation, uniform, Bernoulli, binomial, Poisson, patterned, and sinusoidal distributions. For example, whereas the benefit distributions employed for purposes of describing modeling of vertical and horizontal differentiation with reference to the isocontour curves shown in FIGS. 11 and 12 were described as having, for example, normal (Gaussian) shape, the present invention is not limited thereto, it being possible to employ benefit distributions of any suitable shape for such modeling so long as such shape admits of characterization in terms of mean and correlation values as compared with another benefit distribution serving as baseline. And where modeling of vertical and horizontal differentiation is not carried out, the present invention is not even limited to employment of benefit distributions having shapes admitting of characterization in terms of mean and correlation values.

Although it was mentioned that the term “costs” as used herein generally refers to marginal costs, the present invention is not limited thereto, it being possible to apply the invention to embodiments in which costs as reflected in cost distributions 159 are other than marginal costs.

Although arrows between blocks in the flowcharts of FIGS. 9 and 10 might suggest a certain chronological order to the steps listed therein, this is merely one exemplary order in which such steps may be carried out, it being possible in general to practice the steps listed in such flowcharts in other than the order shown.

As described above, some embodiments of the present invention allow the user to generate partworth customer distributions from market reports, and/or institutional knowledge, and/or consumer surveys, and/or other publically available information. Moreover, some embodiments of the present invention allow the user to combine partworth customer distributions from multiple sources together. That is, some embodiments of the present invention allow the user to “mix and match” partworth customer distributions regardless of whether such partworth customer distributions have been obtained externally as a result of a Conjoint or other such survey of actual customers or whether such partworth customer distributions have been generated internally based on posited preferences of a multiplicity of virtual customers.

Furthermore, the present invention allows a user to tune a market model to obtain customer distributions including partworth data that accurately agrees with observed market characteristics, which would typically be far more time-consuming and expensive to obtain by conducting Conjoint survey.

Moreover, given a set of partworth customer distributions that accurately reflect a market (regardless of whether such partworth customer distributions have been generated internally or obtained from an external source), the present invention allows a user to easily adjust market relationships and parameters to simulate evolving trends and/or one-time events such as product line extensions, increasing or decreasing raw material costs, and entry of competitors, just to name a few examples.

Furthermore, whereas traditional Conjoint analysis deals with discrete levels of attributes, the market simulator/optimizer of the present invention is able to model continuous variation in benefits, which often better reflects the real world.

In addition, the present invention permits simulation results to be presented in continuous fashion in the form of dynamic charts or tweened move-like presentations to show the changing effect over time of varying a parameter under study.

Moreover, unlike conventional simulators, the market simulator/optimizer in accordance with some embodiments of the present invention is easy to use and transparent in that relevant parameters are not hidden behind layers of programming code or accessible only to software experts but are easily accessible by means of a graphical user interface. This facilitates communication among corporate decision makers and allows the market simulator/optimizer in such embodiments to be used as an educational or presentation tool to assist in understanding or communicating relationships between market and partworth distributions as affected by various market components, for example.

Also, application of Nash equilibrium methodology to Conjoint analytical techniques in the market simulator/optimizer of the present invention makes it possible for optimal price to be treated as a dependent variable derived from the profit-maximizing Nash equilibrium point rather than merely as an independent variable to be set arbitrarily by the user or determined as a result of Conjoint analysis, thus permitting more sophisticated modeling of market conditions over any time horizon. For example, in some embodiments, not only is it possible to predict prices as a function of product attributes at some Nash equilibrium point far in the future, but it is also possible to accurately know current profit-maximizing prices as a function of product attributes based on the actual market conditions which exist at present.

Furthermore, the present invention makes it possible for the user to model horizontal and vertical differentiation. In some embodiments, statistical techniques relating vertical differentiation and horizontal differentiation make it possible to fine-tune the simulation engine so as to better reflect market conditions. Moreover, ability of some embodiments of the market simulator/optimizer to generate idealized partworth data based on user-defined distributions (e.g., normal distribution) makes it possible to achieve more accurate results with less input data. For example, some embodiments of the present invention make it unnecessary to repeatedly carry out extensive customer surveys to obtain partworth data representative of varying market conditions.

Also, in some embodiments, simplified and versatile handling of complex statistical data sets makes it possible for the simulation engine to utilize data from a wide variety of sources (including the user's own intuition about the market), reflect multiple simultaneous dynamics in which numerous market changes are simultaneously taken into account, and show how slowly changing circumstances will gestate and cause a market to evolve over time.

As described above, market simulator/optimizers in accordance with one or more embodiments of the present invention allow a user to consider latent differentiation within identical or near-identical features offered by different products. In accordance with one or more embodiments, a user is able to transform a benefit offered by a feature in a continuous manner in order to simulate steady improvements and/or changes in that feature. Furthermore, in some embodiments, a user is able to simulate continuous market trends impacting some or all of the products in the market. Moreover, some embodiments permit a user to simulate the impact of changes to the geographic location of store fronts. Moreover, some embodiments allow a user to simultaneously model the continuous change of feature benefit, market trends, and geographic presence while identifying the optimal selection of discrete features for products within the market.

In addition, some embodiments of market simulator/optimizer of the present invention are capable of modeling feedback conditions for simulating network externalities and other sophisticated market interactions.

It should be emphasized that the above-described embodiments of the present invention are merely possible examples of implementations, merely set forth for a clear understanding of the principles of the invention. Many variations and modifications may be made to the above described embodiments of the invention without departing substantially from the spirit and principles of the invention. All such modifications and variations are intended to be included herein within the scope of this disclosure and the present invention and protected by the following claims.

1. A computer system for visually building a market simulation, the system comprising:
a non-transitory computer memory; and
a processor configured to execute instructions stored in said memory to enable:
a Graphical User Interface (GUI) comprising:
a sector diagram area where a user can place two or more market component icons which correspond to data outputs of (1) a cost distribution of cost of serving customers a modeled product and (2) a benefit distribution of benefit that customers receive from a product feature by purchasing the modeled product, and
component connectors which the user can place to connect market components together,
wherein the arrangement of market components and component connectors creates a market model;
a model compiler which produces a mathematical market simulation based on the layout of the market component icons and component connectors by executing the steps of:
passing said data outputs between said market component icons according to an order of operations defined by said component connectors,
aggregating cost and benefit distributions from said market components,
verifying that mathematical operations represented by market components and the order of operations defined by component connectors are capable of being processed by a profit maximization engine;
a profit maximization engine which applies a Nash equilibrium pricing optimization to the market model to determine a profit maximizing price for the modeled product based on cost and benefit distributions compiled from two or more market components and outputs at least one market metric related to said profit maximizing price, said market metric comprising market share, marginal cost, and customer ratings of each modeled product feature.

2. The computer system of claim 1 wherein at least one of the market component icons is indicative of a price-competitive or non-competitive group, and the profit maximization engine employs a pricing funnel to find the profit-maximizing equilibrium point.

3. The computer system of claim 1 wherein the benefit distribution is statistically generated such that the respective benefits of said feature conform to a substantially random distribution characterized in terms of mean and correlation values relative to a second benefit distribution.

4. The computer system of claim 1 wherein the profit maximization engine is used in iterative fashion to generate a results matrix relating said at least one market metric to a series of benefit distributions having varying mean and correlation values relative to a baseline benefit distribution.

5. The computer system of claim 1 wherein said at least one market metric further comprises one or more items selected from among the group consisting of: product price, market share by quantity of product sold, market share by revenue from sale of product, market share by product profitability, marginal cost of product sold, implicit customer rating of respective product features, and implicit product similarity.

6. The computer system of claim 1 configured to:
generate at least one partworth distribution containing partworth values for a plurality of virtual customers, wherein the system allows the user to give the partworth distribution a desired distribution shape, mean, and standard deviation;
allow the user to tune the partworth distribution to reflect vertical and horizontal differentiation.

7. The computer system of claim 6 wherein the tuning to reflect vertical and horizontal differentiation is carried out in iterative fashion through use of a profit maximization engine.

8. The computer system of claim 6 wherein the tuning to reflect vertical and horizontal differentiation is carried out through use of isocontour curves relating vertical and horizontal differentiation to said at least one market metric.

9. The computer system of claim 1 further configured to tune each benefit distribution, by way of its shape, mean, standard deviation, and correlation, with other benefit distributions by comparison to external market factors that do not include survey responses but may include historic prices, margins, and volumes of the products in the market.

10. The computer system of claim 1 wherein a first partworth distribution having a normal distribution is obtained; and a degree of correlation between product features is used to generate a second partworth distribution from the first partworth distribution.

11. The computer system of claim 1 wherein said profit maximization engine iteratively determines whether a profit-maximizing equilibrium point has been reached by evaluating a consumer surplus and estimated profit for said modeled product at a plurality of price points until a Nash equilibrium is reached in a virtual market of competing products, wherein said consumer surplus is the difference between a benefit of said modeled product and a price of said modeled product, and wherein said estimated profit is based on the difference between the price of said modeled product and cost of said modeled product.

12. The computer system of claim 1 wherein an output from said profit maximization engine can feed back as input to said profit maximization engine during a subsequent calculated iteration.

13. The computer system of claim 1 wherein an output from one profit maximization engine can be linked as an input of a second profit maximization engine in order to simulate a distribution chain from manufacturer to wholesaler to retailer.

14. A method for visually building a market simulation, the method comprising the steps of:
receiving, through a visually represented sector diagram area, instructions from a user for placement of two or more market component icons,
wherein said two or more market component icons correspond to data outputs of (1) a cost distribution of cost of serving customers a modeled product and (2) a benefit distribution of benefit that customers receive from a product feature by purchasing the modeled product;
receiving, through said sector diagram area, instruction from the user for placement of component connectors which connect market components together, where component connectors,
wherein the placement of market components and component connectors within said sector diagram area creates a market model;
producing a mathematical market simulation based on the layout of the market component icons and component connectors by executing the steps of:
passing said data outputs between said market component icons according to an order of operations defined by said component connectors,
aggregating cost and benefit distributions from said market components,
verifying that mathematical operations represented by market components and the order of operations defined by component connectors are capable of being processed by a profit maximization engine;
implementing a profit maximization engine by executing the steps of:
applying a Nash equilibrium pricing optimization to the market model to determine a profit maximizing price for the modeled product based on cost and benefit distributions compiled from two or more market components, and
outputting at least one market metric related to said profit maximizing price, said market metric comprising market share, marginal cost, and customer ratings of each modeled product feature.

15. A computer system for tuning a partworth distribution to reflect vertical and horizontal differentiation in a market as indicated by a market metric, the system comprising:
a memory; and
a processor configured by the memory to perform the steps of:
implementing a profit maximization engine to generate a results matrix relating the market metric to the vertical and horizontal differentiation in the market;
constructing a first isocontour satisfying a first boundary condition for the market metric;
constructing a second isocontour satisfying a second boundary condition for the market metric; and
locating an intersection between the first isocontour and the second isocontour.
